(19) United States
(12) Patent Application Publication
(10) Pub. No.: US 2009/0319436 A1
(43) Pub. Date: Dec. 24, 2009

(54) METHOD AND SYSTEM OF OPINION ANALYSIS AND RECOMMENDATIONS IN SOCIAL PLATFORM APPLICATIONS

(76) Inventors: DELIP ANDRA, Fremont, CA (US); Gaurav Bhatia, New Delhi (IN); Sudeshna Sarkar, West Bengal (IN)

Correspondence Address: Raj Abhyanker LLP, 1580 West, El Camino Real, Suite 8, Mountain View, CA, 94040, US

(21) Appl. No.: 12/141,147

(22) Filed: Jun. 18, 2008

(51) Int. Cl. G06Q 30/00; G06F 17/27

(52) U.S. Cl. 705/80; 704/9

(57) ABSTRACT

A method, apparatus, and system of opinion analysis and recommendations in social platform applications are disclosed. In one embodiment, a method includes processing an opinion data of a user through a platform application interface of a social community environment, the opinion data to include at least one of an opinion and a response of the user, determining an opinion match of the user based on analyzing at least one of an attribute and a polarity of the opinion data using a natural language processing algorithm to match the opinion data across a categorized set of opinions associated with certain ones of a plurality of users of the social community environment, and recommending the opinion targeted to the user based on at least one of the opinion match and a likeness profile determined of the user agnostic of a degree of separation between the user and any of the users.

### FIELD OF TECHNOLOGY

This disclosure relates generally to the technical fields of software, internet and/or language processing technology and, in one example embodiment, to a method, apparatus and system of viral growth extension through recommendation optimization in online communities.

### BACKGROUND

A social platform (e.g., a social community environment) may provide an Application Programming Interface (API) to third-party developers. APIs may allow developers to build (e.g., code, design, develop, etc.) applications on the social platform (e.g., the iLike and RockYou “apps” based on the Facebook API, etc.). They may be provided freely (e.g., the Facebook API and/or the Google Maps API), or under limited access (e.g., to licensed developers), and may enhance a user experience of the social community environment (e.g., by providing additional features and/or functionality to users through the social platform).

An user of the social community environment (e.g., a social network and/or platform such as MySpace®, Facebook®, LinkedIn®, etc.) may interact and/or communicate with other users around shared interests. The user may express himself/herself and/or interact with multiple other users on the social platform by joining groups, discussion boards, forums, polls and/or newsgroups, etc. in the social community environment. The user may communicate directly with individual users by sending messages and/or content to the users and/or posting comments on profile pages of the users. The user may also choose to add (e.g., use, join, etc., on the social platform) a platform application having a resource, a particular feature set and/or a functionality of interest to the user.

However, groups, forums, discussion spaces and/or related resources may not provide information and/or content relevant to the user. Information shared through these resources may not easily provide an insight to the user of opinions and/or positions held by other users relative to those of the user. In addition, they may be scattered, disorganized and/or not intuitively accessible to the user in the social community environment. They may be available on different pages, in arbitrary and/or mismatched categories, across different user contexts, in redundant threads and/or at different times. The user may therefore also not be able to easily choose and/or engage in interactions around specific issues and/or topics of interest to the user.

Furthermore, the user may have limited or no access to other users who share similar interests and/or opinions but have a certain degree of separation from the user in the social community environment. For example, the users may be outside of the user's circle of connections (e.g., friends, social graph, sphere of influence, etc.) in the social community environment.

For example, John is a user of a social community environment. He is also passionate about recycling, as is Mary (e.g., another user). However, Mary may not have published this information on her public profile (e.g., visible to users of the social community environment) and/or may not be connected to John (e.g., as a connection, through a network and/or through common friends in the social community environment). As such, even though John and Mary share a similar viewpoint, they would not be able to easily discover each other.

It may be difficult and time consuming for the user to expand the user's circle of connections (e.g., friends, associates, social graph, etc.) by searching for and adding connections. It may be even more difficult to do so if the user does not already have a real world connection with people. In addition, information available in user profiles may be limited and may not provide sufficient insight about the users' personal preferences (e.g., opinions, ideologies, social affiliations and or personal attributes, etc.) for the user to be compelled to connect with the users.

### SUMMARY

A method, apparatus, and system of opinion analysis and recommendations in social platform applications are disclosed. In one aspect, a method includes processing an opinion data of a user through a platform application interface of a social community environment, the opinion data to include at least one of an opinion and a response of the user, determining an opinion match of the user based on analyzing at least one of an attribute and a polarity of the opinion data using a natural language processing algorithm to match the opinion data across a categorized set of opinions associated with certain ones of a plurality of users of the social community environment, and recommending the opinion targeted to the user based on at least one of the opinion match and a likeness profile determined of the user agnostic of a degree of separation between the user and any of the plurality of users.

The method may include providing a bidding system of an advertising platform to select an advertisement associated with a placement bid from providers (e.g., may include a commercial entity, a brand, a sponsor, and/or a partner). The method may select a winning placement bid based on evaluating a meta data descriptiveness, a relevancy and/or a pricing of the advertisement. The method may feature the advertisement in the response to the opinion data of the user through the advertising platform. The method may also include refining the opinion match based on monitoring a behavior of the user in response to the recommended opinion.

The method may include recommending the opinion targeted to the user based on a behavioral analytic determined of previous users applied to an origination identifier of the user. The origination identifier may include a domain name, a domain extension, a server location, an IP address and/or a network name associated with the user.

The method may include recommending a content targeted to the user based on the opinion match and/or the likeness profile. The content may include a syndicated content, a sponsor content, a partner content, a public content and/or a private content independent of the social community environment. The method may also include determining an insight of the set of opinions based on computing a statistically significant correlation between a demographic attribute of the users and/or an analytic of the opinion match. The method may provide a recommendation of the insight based on analyzing the demographic attribute across a social graph associated with individual users.

The demographic attribute may include an age attribute, a gender attribute, a geographic attribute, a cultural attribute, a social attribute and/or a professional attribute. The method may include analyzing the social graph of the user to determine a network path to include tracing a pattern of influence, an authority, a trust relationship, a patronage and/or an affinity between the user and another user of the users through the social graph. The method may recommend the opinion targeted to the user to another user based on the network path and/or a spreading activation mechanism of the social graph.

The spreading activation mechanism may include propagating an activation of nodes based on a linkage to a set of source nodes determined of the social graph. The method may include recommending a connection of the social community environment targeted to the user based on the likeness profile and/or the insight.

The method may include providing a grouping function to process a selected association and/or a recommended association of the opinion data to any number of users. The method may include providing an activity incentive to the user through assigning a score and/or publishing a rank of the user in the social community environment based on a level of activity of the user.

In another aspect, a method of a processing module includes mapping an opinion data to a classifier schema of the processing module using a natural language processing algorithm that parses at least one of a denotation and a connotation of the opinion data independent of a thread lineage of the opinion data, aggregating a categorized set of opinions associated with a plurality of users based on analyzing at least one of the classifier schema, a meta data identifier and the thread lineage of the opinion data, matching the opinion data to certain ones of the set of opinions through a matching function of the natural language processing algorithm that considers at least one of a hierarchy of objective attributes and a polarity of a subjective attribute of the opinion data, and generating a likeness profile of the user based on determining the opinion match agnostic of a degree of separation between the user and any of the plurality of users across the set of opinions.

The method may include providing a grouping function of the processing module to process a selected association and/or a recommended association of the opinion data to the users. The method may also include seeding the opinion match and/or the likeness profile of the user based on an attribute data determined through a personality test administered of the user. In addition, the method may include refining the opinion match based on monitoring a behavior of the user in response to the recommended opinion. The method may also include generating an evolution of the polarity of the opinion match through the thread lineage over time. The thread lineage may describe a parent, a child and/or a sibling orientation of the opinion data. The method may modify the natural language processing algorithm based on an internationalized and/or a localized instance of the processing module.

In yet another aspect, a system includes a processing module to determine at least one of an opinion match of the opinion data and a likeness profile of a plurality of users of the social community environment using a natural language processing algorithm to match at least one of an attribute and a polarity of the opinion data to certain ones of a categorized set of opinions associated with the plurality of users, a recommendation module to provide an opinion targeted to the user based on at least one of the opinion match and the likeness profile, and an advertising module to feature an advertisement selected from a plurality of providers in a response to the opinion data of the user through an advertising platform of the platform application interface.

The system may include a widget of the processing module that may be embeddable across different websites and/or platforms (e.g., such that the set of opinion data to be aggregated through a user population across different social community environments).

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of an opinion module processing user opinion data through a platform application interface of a social community environment, according to one embodiment.

FIG. 2 is an exploded view of an opinion module illustrated in FIG. 1, according to one embodiment.

FIG. 3 is an exploded view of a processing module illustrated in FIG. 1, according to one embodiment.

FIG. 4 is a system view of user likeness profiles, according to one embodiment.

FIG. 5 is a table view of data referenced by the processing module of FIG. 3, according to one embodiment.

FIG. 6 is a user interface view of a home page of the platform application of FIG. 1, according to one embodiment.

FIG. 7 is a user interface view of a user home page of the platform application of FIG. 1, according to one embodiment.

FIG. 8 is a user interface view of an opinion page displaying an insight and a content response of an advertising platform, according to one embodiment.

FIG. 9 is a user interface view of a score ranking page, according to one embodiment.

FIG. 10 is a user interface view of adding an opinion, according to one embodiment.

FIG. 11 is a user interface view of a user page displaying a likeness profile, according to one embodiment.

FIG. 12 is a diagrammatic representation of a data processing system capable of processing a set of instructions to perform any one or more of the methodologies herein, according to one embodiment.

FIG. 13 is a tree diagram of cluster analysis classification types, according to one embodiment.

FIG. 14 is a data flow diagram of learning a user interest and evaluating a document relevancy, according to one embodiment.

FIG. 15 is a flow chart of learning a user profile, according to one embodiment

FIGS. 16A and 16B are table views of an automatic key phrase extraction algorithm, according to one embodiment.

FIG. 17 is a flow diagram of clustering with hierarchical and incremental approach, according to one embodiment.

FIG. 18 is a block diagram of a clustering results of web search engines algorithm, according to one embodiment.

FIG. 19A is a flow of extracting meaningful words, according to one embodiment.

FIG. 19B is a continuation of the flow of FIG. 20 having additional processes, according to one embodiment.

FIG. 19C is a continuation of the flow of FIG. 21 having additional processes, according to one embodiment.

FIG. 20A is a process flow of processing an opinion data of a user through a platform application interface of a social community environment, according to one embodiment.

FIG. 20B is a continuation of process flow of FIG. 20A, illustrating additional operations, according to one embodiment.

FIG. 20C is a continuation of process flow of FIG. 20B, illustrating additional operations, according to one embodiment.

FIG. 21A is a process flow of mapping an opinion data to a classifier schema of the processing module using a natural language processing algorithm, according to one embodiment.

FIG. 21B is a continuation of process flow of FIG. 21A, illustrating additional operations, according to one embodiment.

Other features of the present embodiments will be apparent from the accompanying drawings and from the detailed description that follows.

### DETAILED DESCRIPTION

A method, apparatus, and system of opinion analysis and recommendations in social platform applications are disclosed are disclosed are disclosed. Although the present embodiments have been described with reference to specific example embodiments, it will be evident that various modifications and changes may be made to these embodiments without departing from the broader spirit and scope of the various embodiments.

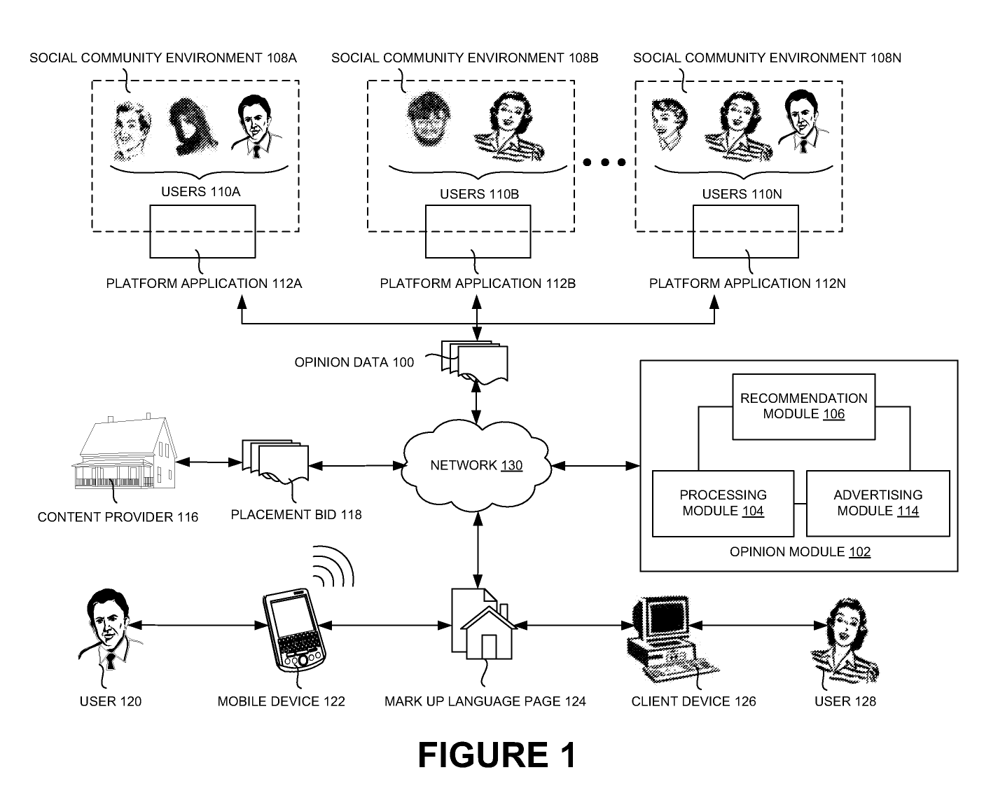

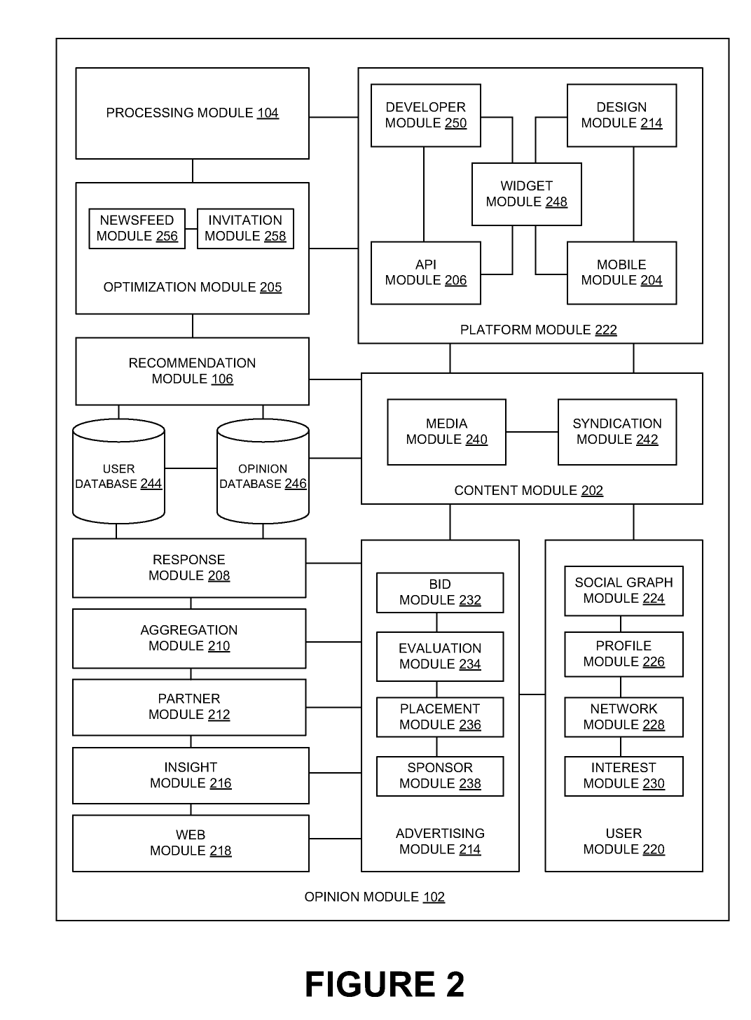

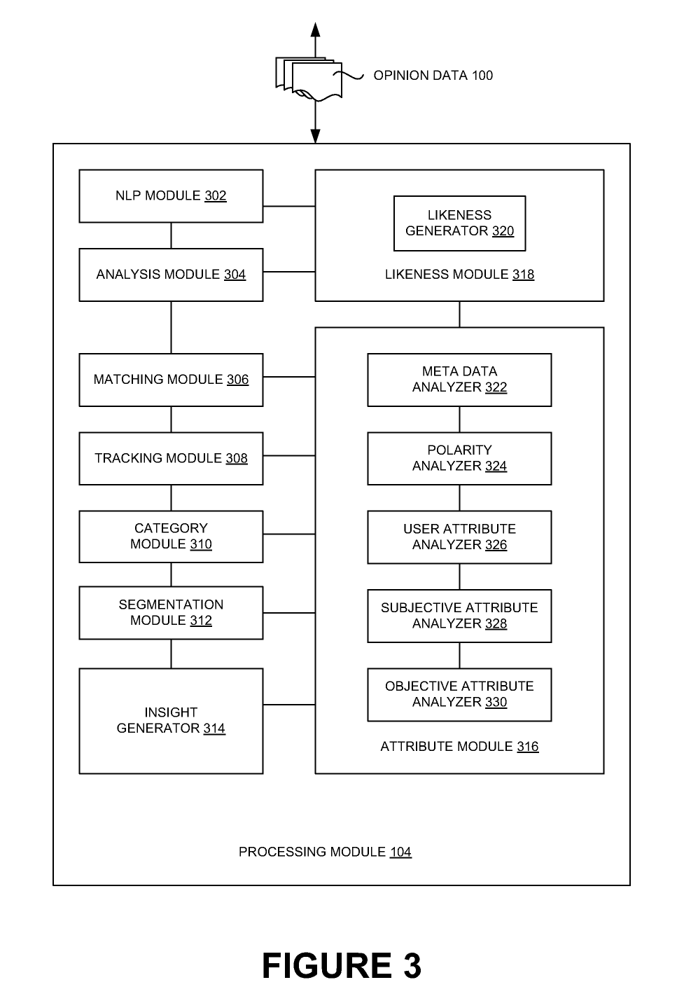

In one embodiment, a method includes processing an opinion data (e.g., the opinion data 100 of FIG. 1) of a user (e.g., using the processing module 104 of FIG. 1) through a platform application interface of a social community environment (e.g., the social community environment 108A-N of FIG. 1), the opinion data 100 to include at least one of an opinion and a response of the user, determining an opinion match of the user based on analyzing (e.g., using the analysis module 304 of FIG. 3) at least one of an attribute and a polarity of the opinion data 100 (e.g., using the polarity analyzer 324 of FIG. 3) using a natural language processing algorithm (e.g., from the processing module 104 of FIG. 1) to match the opinion data 100 across a categorized set of opinions (e.g., using the matching module 306 of FIG. 3) associated with certain ones of users (e.g., the users 110A-N of FIG. 1) of the social community environment 108A-N, and recommending the opinion targeted to the user (e.g., using the recommendation module 106 of FIG. 2) based on any one of the opinion match and a likeness profile determined of the user (e.g., using the likeness module 318 of FIG. 3) agnostic of a degree of separation between the user and any of the users.

In another embodiment, a method of a processing module (e.g., the processing module 104 of FIG. 1) includes mapping an opinion data (e.g., the opinion data 100 of FIG. 1) to a classifier schema of the processing module 104 using a natural language processing algorithm that parses any one of a denotation and a connotation of the opinion data 100 (e.g. using the NLP module 302 of FIG. 3) independent of a thread lineage of the opinion data 100, aggregating a categorized set of opinions (e.g., using the aggregation module 210 of FIG. 2) associated with users (e.g., using the category module 310 of FIG. 3) based on analyzing any one of the classifier schema, a meta data identifier and the thread lineage of the opinion data (e.g., using the analysis module 304 of FIG. 3), matching the opinion data 100 to certain ones of the set of opinions through a matching function (e.g., using the matching module 306 of FIG. 3) of the natural language processing algorithm (e.g., using the NLP module 302 of FIG. 3) that considers any one of a hierarchy of objective attributes and a polarity of a subjective attribute of the opinion data 100, and generating a likeness profile of the user (e.g., using the likeness module 318 of FIG. 3) based on determining the opinion match (e.g., using the matching module 306 of FIG. 3) agnostic of a degree of separation between the user and any of the users across the set of opinions (e.g., using the opinion module 102 of FIG. 1).

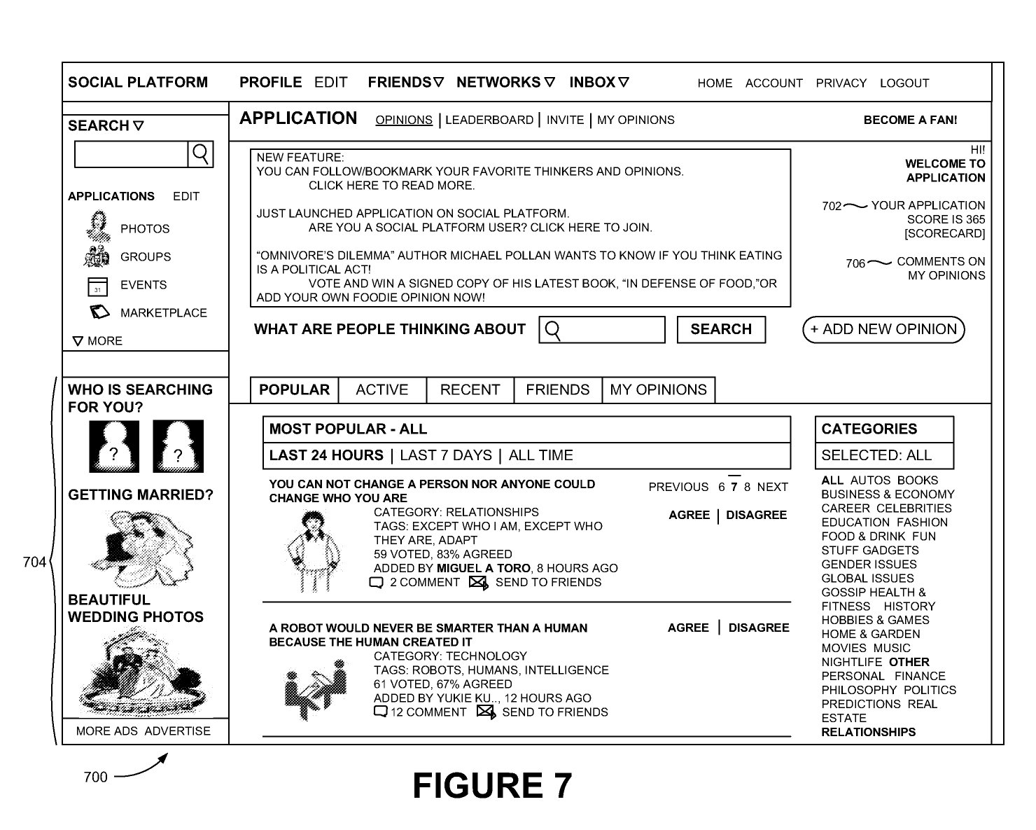

In yet another embodiment, a system includes a processing module (e.g., the processing module 104 of FIG. 1) to determine any one of an opinion match of the opinion data (e.g., the opinion data 100 of FIG. 1) (e.g., using the opinion module 102 of FIG. 1) and a likeness profile of a users (e.g., the users 110A-N of FIG. 1) of a social community environment (e.g., the social community environment 108A-N of FIG. 1) using a natural language processing algorithm (e.g., using the NLP module 302 of FIG. 3) to match any one of an attribute and a polarity of the opinion data 100 (e.g., using the matching module 306 of FIG. 3) to certain ones of a categorized set of opinions associated with the users, a recommendation module (e.g., the recommendation module 106 of FIG. 2) to provide an opinion targeted to the user (e.g., using the opinion module 102 of FIG. 1) based on at least one of the opinion match (e.g., using the matching module 306 of FIG. 3) and the likeness profile, and an advertising module (e.g., the advertising module 114 of FIG. 1) to feature an advertisement selected from providers in a response to the opinion data (e.g., as illustrated in FIG. 7) of the user (e.g., using the response module 208 of FIG. 2) through an advertising platform of the platform application interface.

FIG. 1 is a system view of an opinion module (e.g., the opinion module 102 of FIG. 1) processing user opinion data through a platform application interface of a social community environment (e.g., the social community environment 108A-N of FIG. 1), according to one embodiment. Particularly, FIG. 1 illustrates an opinion data 100, the opinion module 102, a processing module 104, a recommendation module 106, a social community environment 108A-N, users 110A-N, platform application 112A-N, an advertising module 114, a content provider 116, a placement bid 118, an user 120, a mobile device 122, a mark up language page 124, a client device 126, an user 128, and a network 130, according to one embodiment.

The opinion data 100 may be information (e.g., a natural language, a thought, an opinion, etc.) associated with content that may be posted on the social community environment 108A-N in which the users may share their opinion and/or response with other users. The opinion module 102 may also process and/or recommend the opinion data 100 of the users 110A-N of the social community environment 108A-N. The processing module 104 may determine the opinion match (e.g., same opinion on a query, or having similar opinion, etc.) of the opinion data 100 and/or the likeness profile of the users 110A-N (e.g., having similarity in profile content, etc.) of the social community environment 108A-N. The recommendation module 106 may provide the opinion targeted to the user based on the opinion match and/or the likeness profile. The social community environment 108A-N may be a community in which users may share their interests (e.g., sports, music, movies, etc.) with other users having similar and/or different interests online. The users 110A-N may use the social community environment 108A-N for communicating with the society online (e.g., friends, relatives, peers, colleagues, unknown people, etc.).

The platform application 112A-N may be a cross platform/channel application that may allow users to express their opinions (e.g., their feeling, their thoughts, etc.) and/or then interact with that opinion allowing them to share and discuss it with friends and/or from people around the world (e.g., may be like a discussion forum). The advertising module 114 may provide advertisements selected from providers (e.g., companies who may want to market their products through advertisements, etc.) associated with the opinion data 100 of the users.

The content provider 116 (e.g., a commercial entity, a brand, a sponsor, a partner, etc.) may be entities who may wish their content to be present (e.g., may be for advertisements, sponsoring on events, etc.) on the social community environment 108A-N. The placement bid 118 may select the winning placement bid based on evaluation of the meta data descriptiveness, the relevancy, and/or the pricing of the advertisement.

The user 120 may be individuals who may be end users who may access the opinion data 100 through the various data processing client devices (e.g., mobile device 122, a computer, laptop, etc.). The mobile device 122 may be a device used for communication and/or for processing information (e.g., interacting with the websites, forums, mail, chat, etc.) through the network 130. A mark up language page 124 (e.g., built using HTML, DHTML, VB-script, Java-script, AJAX, etc.) may be a webpage (e.g., GUI) which may provide a platform for the users to communicate with the online social community environment 108A-N. The client device 126 may be a laptop, a desktop computer, a set-top box, etc. which may enable the user to communicate with other users online through some websites (e.g., the social community environment 108A-N) through the network 130. The network 130 (e.g., may be wireless, wired, etc.) may be a local area network, a wide area network, an internet network, etc. which may enable the users to communicate with the other users from their client devices (e.g., may be by using a computer, mobile device, etc.).

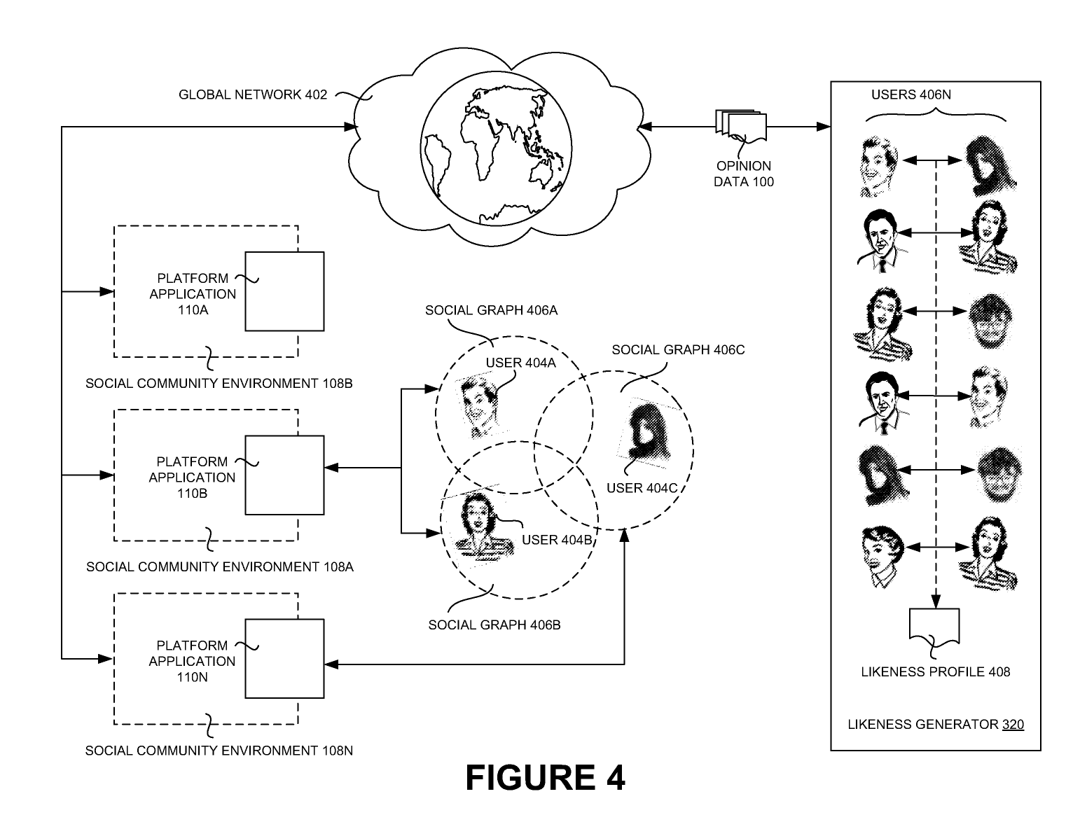

In example embodiment, the opinion data 100 may be aggregated from users through various platform applications 112A-N of the social community environments 108A-N. The opinion module 102 may process the opinion data 100 to match and/or to provide recommendation to the users based on the opinion match and/or likeness profile (e.g., the likeness profile 408 of FIG. 4). The user may interact (e.g., post, respond, receive, etc) through the mark up language page 124 from the client devices. The content provider 116 may provide content (e.g., advertisement, sponsorship, etc) based on the opinion data 100 by placing a bid.

In one embodiment, the opinion data 100 of a user may be processed through a platform application interface (e.g., using the processing module 104 of FIG. 1) of the social community environment 108A-N, the opinion data 100 may include an opinion and a response of the user. The advertisement in the response to the opinion data of the user may be featured through the advertising platform (e.g., using the advertising module 114 of FIG. 1). The providers may include a commercial entity, a brand, a sponsor, a partner, etc. It may be recommended the opinion targeted to the user (e.g., using the recommendation module 106 of FIG. 1) based on a behavioral analytic determined of previous users applied to an origination identifier of the user. The origination identifier may include a domain name, a domain extension, a server location, an IP address and/or a network name associated with the user.

A recommendation of the insight based on analyzing the demographic attribute may be provided (e.g., using the recommendation module 106 of FIG. 2) across a social graph (e.g., the social graph 406A-C of FIG. 4) associated with individual ones of the users 110A-N. The demographic attribute may include an age attribute, a gender attribute, a geographic attribute, a cultural attribute, a social attribute (e.g., interests of users, hobbies of users, music tastes of users, etc.) and/or a professional attribute.

It may be recommended (e.g., using the recommendation module 106 of FIG. 1) a connection of the social community environment 108A-N targeted to the user based on the likeness profile and the insight. A grouping function may be provided to process (e.g., using the processing module 104 of FIG. 1) a selected association and a recommended association of the opinion data 100 to any number of the users 110A-N. An activity incentive may be provided to the user through assigning a score and/or publishing a rank of the user in the social community environment 108A-N based on a level of activity of the user. The opinion data 100 may be mapped to a classifier schema of the processing module 104 using a natural language processing algorithm that may parses a denotation and a connotation of the opinion data 100 independent of a thread lineage of the opinion data 100.

A categorized set of opinions associated with users based on analyzing the classifier schema may be aggregated a meta data identifier and the thread lineage of the opinion data 100 (e.g., using the aggregation module 210 of FIG. 2). The opinion match based on monitoring a behavior of the user may be refined in response to the recommended opinion.

The processing module 104 may determine an opinion match of the opinion data 100 and a likeness profile of users of the social community environment 108A-N using the natural language processing algorithm to match (e.g., using the NLP module 302 of FIG. 3) an attribute and/or a polarity of the opinion data 100 (e.g., using the attribute module 316 of FIG. 3) to certain ones of a categorized set of opinions associated with the plurality of users 110A-N. The recommendation module 106 may provide an opinion targeted to the user (e.g., using the opinion module 102 of FIG. 1) based on the opinion match and the likeness profile.

The advertising module 114 may feature an advertisement selected from a providers in a response to the opinion data 100 of the user through an advertising platform of the platform application interface. An evolution of the polarity of the opinion match may be generated through the thread lineage over time. The thread lineage may describe a parent, a child and/or a sibling orientation of the opinion data 100 (e.g., using the opinion module 102 of FIG. 1). A widget of the processing module 104 may be embeddable across different websites and platforms such that the set of opinion data 100 may be aggregated through a user population across different social community environments.

FIG. 2 is an exploded view of an opinion module (e.g., the opinion module 102 of FIG. 1) illustrated in FIG. 1, according to one embodiment. Particularly, FIG. 2 illustrates the opinion module 102 having the processing module 104, the advertising module 114, a content module 202, a mobile module 204, an API module 206, a response module 208, an aggregation module 210, a partner module 212, a design module 214, an insight module 216, a web module 218, an user module 220, a platform module 222, a social graph module 224, a profile module 226, a network module 228, an interest module 230, a bid module 232, an evaluation module 234, a placement module 236, a sponsor module 238, a media module 240, a syndication module 242, an user database 244, an opinion database 246, a widget module 248, and a developer module 250, according to one embodiment.

The content module 202 may provide and/or manage contents (e.g., advertisements, sponsorship, information to the website, etc.). The mobile module 204 may have necessary communication logic in order to communicate information with the mobile devices. The API module 206 may enable development of APIs for communication between the users in the social community environment 108A-N. The response module 208 may include of logic which may help the recommendation module 106, the advertising module 114, and/or to make decisions to target information (e.g., recommendations, advertisements, etc) to the user.

The aggregation module 210 may enable aggregation of information (e.g., opinion, responses, etc.) from the users 110A-N. The partner module 212 may enable partners (e.g., patrons, entities, individuals, etc.) who may form the part of the content providers. The design module 214 may enable design of the user interface as per the requirement of the platform application 112A-N. The insight module 216 may help in determining an insight of the set of opinions based on computing a statistically significant correlation between a demographic attribute of the users. The web module 218 may enable building of the mark up language page 124 as per the requirement. The user module 220 may manage the grouping of the users from the social community environments 108A-N.

The platform module 222 may enable communication of data between users of the social community environment 108A-N. The social graph module 224 may globally map users of the social community environment 108A-N and their relation with other users (e.g., may be through friendship, business, etc.). A social graph (e.g., the social graph 406A-C of FIG. 4) may contain a combination of public nodes, private nodes, public edges, private edges, etc. The profile module 226 may mine for various profiles in the social community environments 108A-N. The network module 228 may take data (e.g., the opinion data 100 of FIG. 1) from the social community environments 108A-N. The interest module 230 may mine for interests associated with the users of the social community environment 108A-N.

The bid module 232 may provide a bidding system of the advertising platform to select an advertisement associated with the placement bid from the providers (e.g., content providers, etc.). The evaluation module 234 may evaluate and select a wining placement bid based on various parameters (e.g., metadata, descriptiveness, relevancy, etc.). The placement module 236 may place the selected advertisements in the mark up language page 124 of the user. The sponsor module 238 may enable sponsors who may want to place their content in the mark up language page 124 (e.g., may be by sponsoring). The media module 240 may enable users, sponsors, etc. to communicate media content (e.g., music, flash, video, etc.) to users of the social community environment 108A-N.

The syndication module 242 may enable a section of websites (e.g., part of website content) to be included (e.g., by licensing) in the mark up language page 124 displayed to the user. The user database 244 may be a collection of user data (e.g., profile information, interests, etc.) of the social community environment 108A-N. The opinion database 246 may be a collection of the opinion data 100 from the different users of the social community environment 108A-N. The widget module 248 may enable widgets that may be embedded across different websites (e.g., for aggregating the opinion data from different community environment). The developer module 250 may allow various platform applications to be developed for setting a platform for the users to communicate in the social community environment 108A-N.

In example embodiment, the opinion module 102 may include the content module 202, the recommendation module 106, the response module 208, the aggregation module 210, the partner module 212, the insight module 216, the web module 218, the user module 220, the platform module 222, the user database 244, and the opinion database 246. In addition, the user module 220 may include the social graph module 224, the profile module 226, the network module 228, and the interest module 230. The advertising module 114 may include the bid module 232, the evaluation module 234, the placement module 236 and the sponsor module 238. The content module 202 may include the media module 240 and the syndication module 242. The platform module 222 may include the mobile module 204, the API module 206, the design module 214, the widget module 248, and the developer module 250. The embodiments described herein may communicate with each other.

In one embodiment, a winning placement bid may be selected based on evaluating (e.g., using an evaluation module 234 of FIG. 2) a meta data descriptiveness, a relevancy and/or a pricing of the advertisement (e.g., using the advertising module 114 of FIG. 1). The advertisement in the response to the opinion data of the user (e.g., using the response module 208 of FIG. 2) may be featured through the advertising platform (e.g., using the advertising module 114 of FIG. 1). It may be recommended a content targeted to the user (e.g., using the recommendation module 106 of FIG. 2) based on the opinion match and the likeness profile 408.

The content may include a syndicated content, a sponsor content, a partner content, a public content and/or a private content independent of the social community environment 108A-N. An insight of the set of opinions based on computing a statistically significant correlation may be determined (e.g., using the insight module 216 of FIG. 2) between a demographic attribute of the users 110A-N (e.g., using the attribute module 316 of FIG. 3) and an analytic of the opinion match (e.g., using the opinion module 102 of FIG. 1).

FIG. 3 is an exploded view of a processing module illustrated in FIG. 1, according to one embodiment. Particularly, FIG. 3 illustrates the processing module 104 having an NLP module 302, an analysis module 304, a matching module 306, a tracking module 308, a category module 310, a segmentation module 312, an insight module 314, an attribute module 316, a likeness module 318, a likeness generator 320, a meta data analyzer 322, a polarity analyzer 324, an user attribute analyzer 326, a subjective attribute analyzer 328, and an objective attribute analyzer 330, according to one embodiment.

The NLP module 302 may match the attribute and/or the polarity of the opinion data 100 to the certain ones of categorized set of opinions associated with the users. The analysis module 304 may analyze the demographic attribute across the social graph 406A-C associated with the users of the social community environment 108A-N. The matching module 306 may match the opinion data 100 and/or the likeness profile through the social graph of the users in the social community environment 108A-N. The tracking module 308 may track pattern of influence, an authority, a trust relationship, a patronage and/or the affinity between the user and other users through the social graph 406A-C.

The category module 310 may categorize the set of opinions in the opinion data 100 associated with the users of the social community environment 108A-N. The segmentation module 312 may segment the opinions into different categories from the opinion data 100. The insight module 314 may provide an insight based on analyzing the demographic attribute across the social graph 406A-C of the social community environment 108A-N. The attribute module 316 may segment various kinds of attributes of the users of the social community environment 108A-N across the social graph 406A-C. The likeness module 318 may generate a likeness profile of the user based on determining the opinion match agnostic of the degree of separation between the user and the other users.

The likeness generator 320 may generate the likeness between the user profiles based on likeness of the users of the social community environment 108A-N. The meta data analyzer 322 may analyze the meta data of the social community environment platforms for categorizing the set of the opinions. The polarity analyzer 324 may analyze of the polarity of a subjective attribute of the opinion data 100. The user attribute analyzer 326 may analyze the attributes associated with user profile in the social community environment 108A-N. The subjective attribute analyzer 328 may analyze the opinion data 100 for subjective attributes based on opinions of the users of the social community environment 108A-N. The objective attribute analyzer 330 may analyze the opinion data 100 for objective attributes of the users of the social community environment 108A-N.

In example embodiment, the processing module 104 may include the NLP module 302, the analysis module 304, the matching module 306, the tracking module 308, the category module 310, the segmentation module 312, the insight module 314, the attribute module 316, and the likeness module 318. In addition, the attribute module 316 may include the meta data analyzer 322, the polarity analyzer 324, the user attribute analyzer 326, the subjective attribute analyzer 328, and the objective attribute analyzer 330. The likeness module 318 may include the likeness generator 320, according to one embodiment. The embodiments described herein may communicate with each other.

In one embodiment, an opinion match of the user based on analyzing any one of an attribute and a polarity of the opinion data may be determined (e.g., using the matching module 306 of FIG. 3) using a natural language processing algorithm to match the opinion data across a categorized set of opinions associated with certain ones of a users (e.g., the users 110A-N of FIG. 1) of the social community environment 108A-N. The opinion targeted to the user based on any one of the opinion match (e.g., the matching module 306 of FIG. 3) and a likeness profile determined of the user agnostic of a degree of separation may be recommended (e.g., using the recommendation module 106 of FIG. 2) between the user and any one of the users.

The opinion match based on monitoring a behavior of the user (e.g., using the matching module 306 of FIG. 3) may be refined in response to the recommended opinion. The opinion data 100 may be matched (e.g., using the matching module 306 of FIG. 3) to certain ones of the set of opinions through a matching function of the natural language processing algorithm (e.g., using the NLP module 302 of FIG. 3) that considers a hierarchy of objective attributes and/or a polarity of a subjective attribute of the opinion data 100.

The opinion data 100 may be matched (e.g., using the matching module 306 of FIG. 3) to certain ones of the set of opinions through a matching function of the natural language processing algorithm (e.g., using the NLP module 302 of FIG. 3) that considers a hierarchy of objective attributes and/or a polarity of a subjective attribute of the opinion data 100. The opinion match and the likeness profile 408 of the user based on an attribute data determined (e.g., using the processing module 104 of FIG. 1) may be seeded through a personality test administered of the user. The natural language processing algorithm (e.g., of the NLP module 302 of FIG. 3) based on an internationalized and a localized instance of the processing module 104 may be modified.

FIG. 4 is a system view of user likeness profiles, according to one embodiment. Particularly, FIG. 4 illustrates the opinion data 100, the social community environment 108A-N, the platform application 112A-N, the likeness generator 320, a global network 402, a user 404A-C, users 404N, a social graph 406A-C, and a likeness profile 408, according to one embodiment.

The global network 402 may be an international network for people who may be interested to communicate (e.g., business, friendship, share opinions, etc.) with other users globally in the social community environment 108A-N. The users 404A-C may be the users of the social community environment 108A-N who may be interested in communicating (e.g., share opinions, sharing thoughts, etc.) with other users globally. The users 406N may be a set of users of the social community environment 108A-N who may have similar interests, tastes, etc. and/or who may have the same likeness. The social graph 406A-C may be a global mapping of the users of the social community environment 108A-N and their relation with other users (e.g., may be through friendship, business, etc.). The likeness profile 408 may be profile that may be generated which may include information based on the attribute data determined through the personality test administered to the users.

In example embodiment, the users 404A-C may have their own social graphs which may be similar (e.g., may be partially) to the social graphs of the other users of the social community environment 108A-N. The opinion data 100 may be aggregated from the users of the social community environment 108A-N through the global network 402. The likeness generator 320 may generate the likeness profile 408 based on analyzing various attributes and likeness of the users of the social community environment 108A-N.

In one embodiment, the social graph 406A-C of the user may be analyzed (e.g., using the analysis module 304 of FIG. 3) to determine a network path (e.g., using the network module 228 of FIG. 2) to include tracing a pattern of influence, an authority, a trust relationship, a patronage and/or an affinity between the user and another user of the users 110A-N through the social graph 406A-C. The opinion targeted to the user may be recommended (e.g., using the recommendation module 106 of FIG. 1) to another user based on the network path and a spreading activation mechanism of the social graph 406A-C. The spreading activation mechanism may include propagating an activation of nodes based on a linkage to a set of source nodes determined of the social graph 406A-C. A likeness profile 408 of the user based on determining the opinion match agnostic of a degree of separation (e.g., using the likeness module 318 of FIG. 3) may be generated between the user and any of the users across the set of opinions (e.g., using the opinion module 102 of FIG. 1).

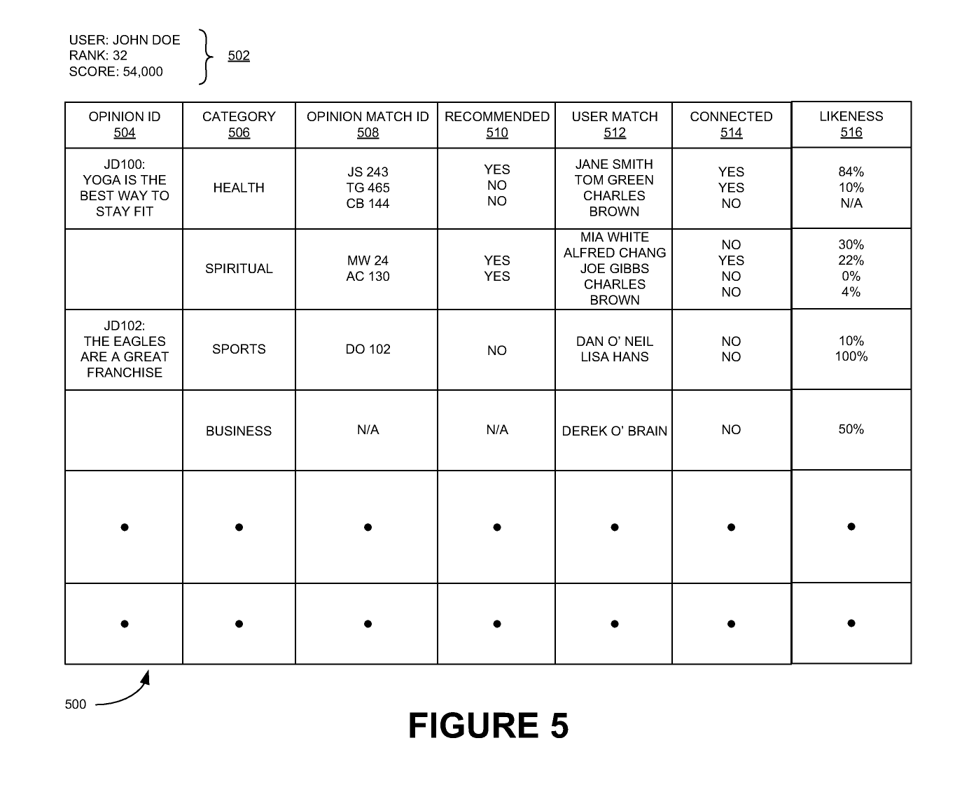

FIG. 5 is a table view of data referenced by the processing module of FIG. 3, according to one embodiment. Particularly, FIG. 5 illustrates a user field 502, an opinion ID field 504, a category field 506, an opinion match ID field 508, a recommended field 510, a user match field 512, a connected field 514, and a likeness field 516, according to one embodiment.

The user field 502 may illustrate user name, rank, and/or score associated to the user. The opinion ID field 504 may illustrate various opinion IDs along with the opinion data associated with the category field 506. The category field 506 may illustrate category of the opinion associated with the opinion ID field 504. The opinion match ID field 508 may illustrate matching opinion codes associated with other users through the social graph 406 A-C globally. The recommended field 510 may illustrate recommendations made to the user based on the opinion match and the likeness profile 408.

The user match field 512 may illustrate the other users whose profile may match the profile of the user (e.g., may be partially or fully) in various aspects (e.g., categories, opinions, likeness, etc.). The connected field 514 may illustrate the users who may be connected to the user through the social community environment 108A-N. The likeness field 516 may illustrate percentage of likeness between the other users and the user.

In example embodiment, the user field 502 may illustrate John Doe ranked 32 and having a score of 54,000. The opinion ID field 504 may illustrate opinion “yoga is the best way to stay fit” associated to opinion ID JD100 in first row, and “The eagles are a great franchise” associated to ID JD102 in third row. The category field 506 may illustrate categories of opinion data such as “health” in the first row, “spiritual” in the second row, and “sports” in third row, “business” in fourth row. The opinion match ID field 508 may illustrate “JS 243, TG 465, CB 144” in the first row, “MW 24, AC 130” in the second row, “DO 102” in the third row, and N/A in the fourth row. The recommended field 510 may illustrate “yes, no, no” associated with the opinion match ID field 508 in the first row, “yes, yes” associated with the opinion match ID field 508 in the second row, “no” associated with the opinion match ID field 508 in the third row, and N/A in the fourth row.

The user match field 512 may illustrate “Jane smith, Tom Green, Charles Brown” in the first row, “Mia white, Alfred Chang, Joe Gibbs and Charles Brown” in the second row, “Dan O'Neil, Lisa Hans” in the third row, and “Derek O'Brain” in the fourth row. The connected 514 may illustrate “yes, yes, no” associated with the user match field 512 in the first row, “no, yes, no, no” associated with the user match field 512 in the second row, “no, no” associated with the user match field 512 in the third row, and “no” associated with the user match field 512 in the fourth row. The likeness field 516 may illustrate “84%, 10%, N/A” associated with the user match field 512 in the first row, “30%, 22%, 0%, 4%” associated with the user match field 512 in the second row, “10%, 100%” associated with the user match field 512 in the third row and “50%” associated with the user match field 512 in the fourth row.

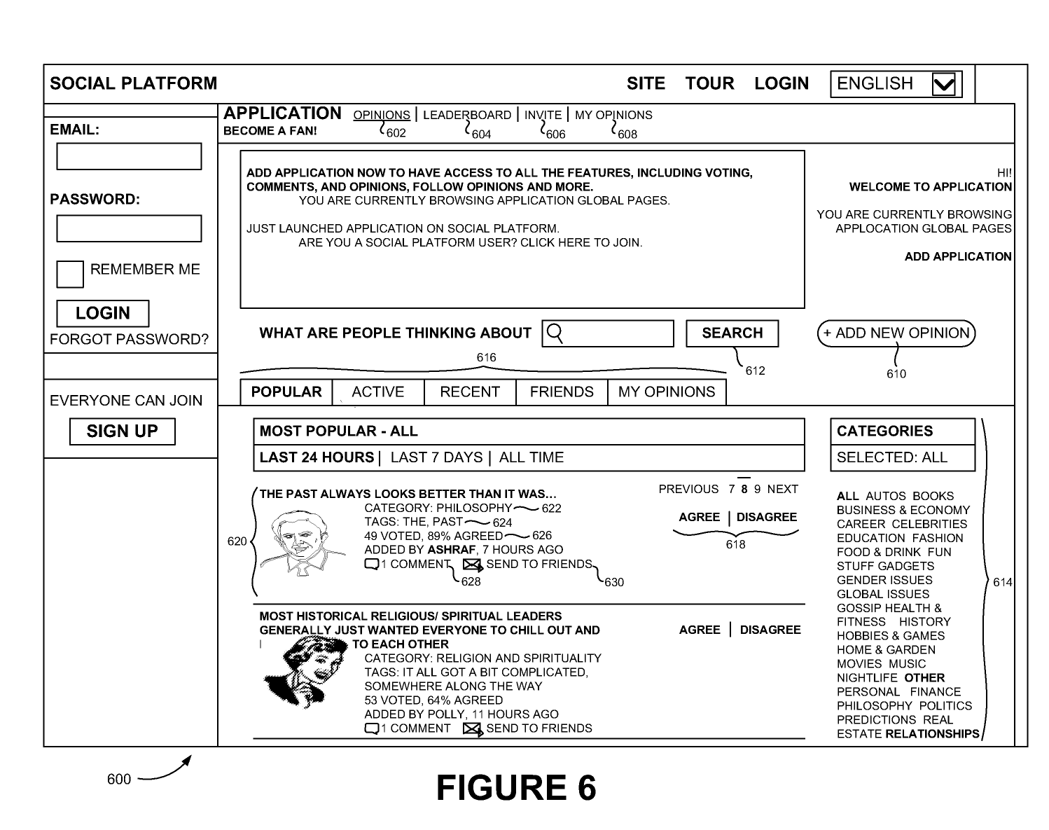

FIG. 6 is a user interface view of a home page of the platform application of FIG. 1, according to one embodiment. Particularly, FIG. 6 illustrates opinions link 602, a leaderboard link 604, an invite link 606, my opinions link 608, an add new opinion button 610, a search button 612, a categories 614, an opinion block 616, an agree/disagree option 618, opinion section 620, an associated category 622, an associated tags 624, number of votes 626, number of comment 628, and send the opinion to friends link 630, according to one embodiment.

The opinions link 602 may navigate the user of the page to the opinion page where opinions based on various categories are displayed. The leaderboard link 604 may navigate the user of the page to opinions start page, where the opinions may be created. The invite link 606 may enable the user to invite the other users to join for adding/commenting on the opinions. The “my opinions link 608” may enable the user to navigate to the pages that may display the users opinions. The “add new opinion button 610” may enable the user to add new opinions associated to the topics of his choice. The search button 612 may enable the user to search about individuals thinking on various and associated opinions over the global network 402. The categories 614 may display various categories that the user may choose based on his interest. The opinion block 616 may illustrate various opinions based on various categories. The agree/disagree option 618 may enable the user to air his voice for or against the opinion of the other users. The opinion section 620 may illustrate the opinion of the other user along with categories, tags, vote and/or percentage of agreement, etc.

The associated category 622 may illustrate the category on which the other user has selected to air his opinion. The associated tags 624 may enable the user to add associated tags that may allow the other users to reach to the exact page while on search. The number of votes 626 may illustrate the number of people who had voted for the opinion and associated percentage of voters who agreed on the opinion. The number of comment 628 may illustrate number of comments made on the opinion. The “send the opinion to friends link 630” may enable the user of the page to send the opinion to friends of his choice which the user may have added.

In example embodiment, FIG. 6 illustrates a user interface social platform page 600 that may illustrate an application with various options to add/remove/comment, etc. on opinions of the user and other users.

FIG. 7 is a user interface view of a user home page of the platform application of FIG. 1, according to one embodiment. Particularly, FIG. 7 illustrates a score 702, an ad 704, and a block 706, according to one embodiment.

The score 702 may illustrate a score that may be scored by the user based on the users activity. The ad 704 may be an advertisement based on the opinions that may be present on the page. The block 706 may enable the user to navigate to a page which may illustrate comments by the other users based on the user's opinion.

In example embodiment, the FIG. 7 may illustrate user interface social platform page 700 that may illustrate the user's page with various features like score, comments, etc.

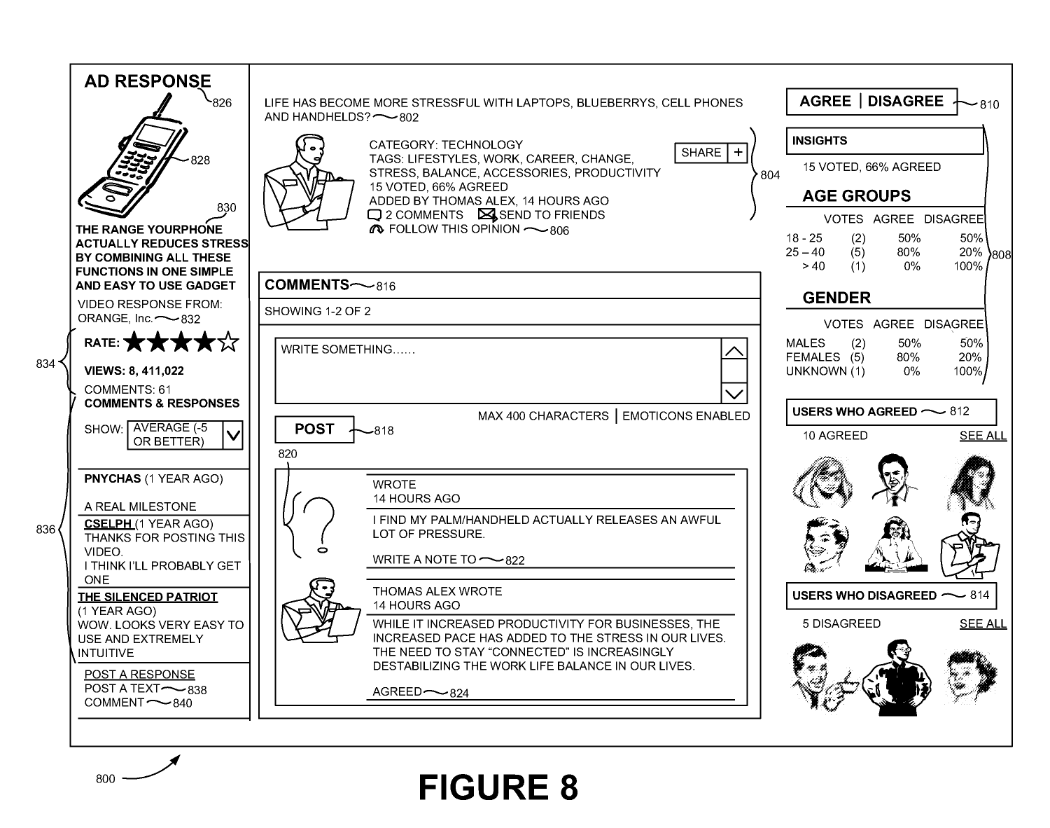

FIG. 8 is a user interface view of an opinion page displaying an insight and a content response of an advertising platform, according to one embodiment. Particularly, FIG. 8 illustrates an opinion 802, a block 804, a follow up option 806, insights 808, an agree/disagree block 810, a block 812, a block 814, block 816, a post 818, a block 820, a block 822, an opinion block 824, an ad response 826, an ad 828, opinion on ad 830, a video response section 832, a rate block 834, a block 836, post a response option 838, and a post a text comment 840, according to one embodiment.

The opinion 802 may be an opinion of the other user on a particular topic. The block 804 may illustrate various attributes associated with the comment. The follow up option 806 may enable the user to follow up to the comment made by the other users. The insights 808 may illustrate the insights like the possibility of the voters, percentage that the users may agree/disagree, etc. The agree/disagree block 810 may enable the user of the page to air his opinion to agree/disagree on the insights. The block 812 may illustrate the users who have agreed on the opinion (e.g., the opinion 802). The block 814 may illustrate the users who have disagreed on the opinion (e.g., the opinion 802).

The block 816 may illustrate various comments made by the user as well as the other users. The post 818 may enable the user to write comments on the opinion 802 and post it on the global network 402. The block 820 may illustrate a comment made by the other user. The block 822 may be a link which may enable the user write an opinion on the comment made by the other users. The opinion block 824 may illustrate the opinion of the user (e.g., agree, disagree, etc.) on the opinion of other users. The ad response 826 may illustrate the responses of the users of the social community environment 108A-N. The ad 828 may illustrate the ad on which the user may have made comments, added opinions, etc.

The opinion on ad 830 may illustrate the opinion made on the ad. The video response section 832 may provide a link that may navigate the user to a video response on the ad. The rate block 834 may illustrate ratings on the opinion including number of viewers, comments, etc. The block 836 may illustrate comments and responses on the opinion. The post a response option 838 may enable the user of the page to post a response to the opinion of the other users. The post a text comment 840 may enable the user to post a comment in the form of text on the opinion of the other users.

In example embodiment, FIG. 8 may illustrate user interface view 800 for airing an opinion/comment on the opinion made by the other users along with ad opinions, associated responses on the opinions, according to one embodiment.

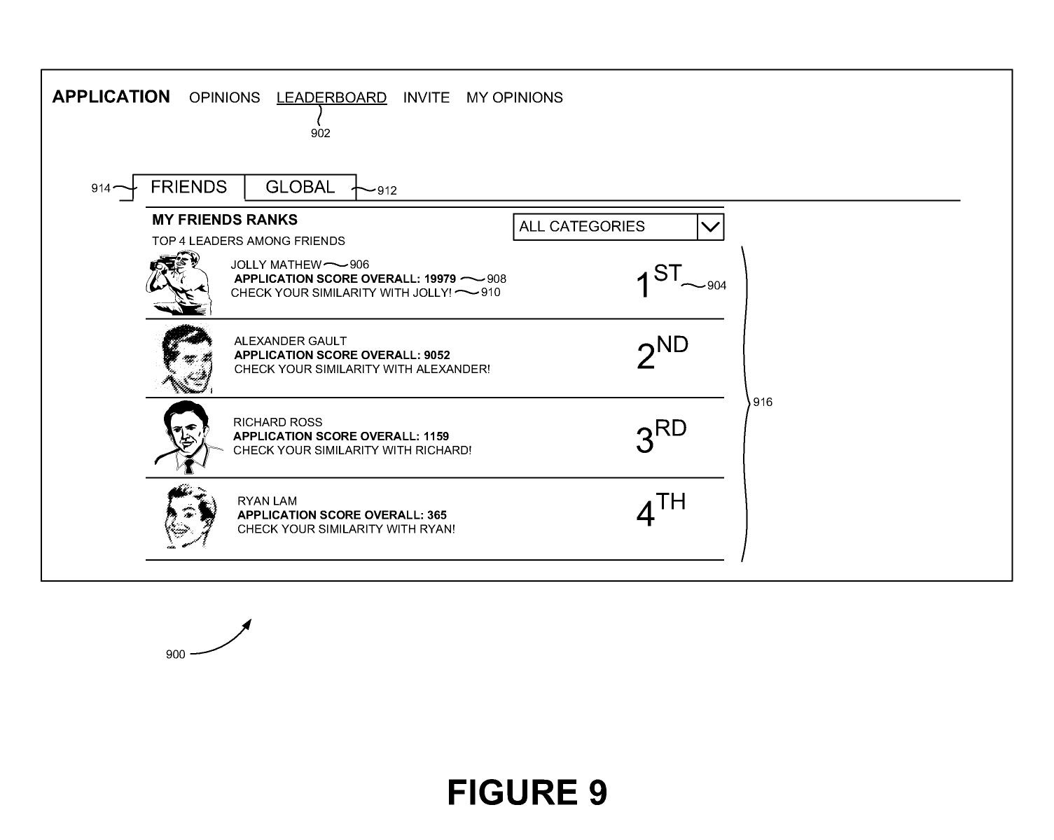

FIG. 9 is a user interface view of a score ranking page 900, according to one embodiment. Particularly, FIG. 9 illustrates a leader board 902, leader place indicator 904, a leader name 906, a section 908, a section 910, a global option 912, a friends option 914, and a block 916, according to one embodiment.

The leader board 902 may enable the user to navigate to the top scorers' page. The leader place indicator 904 may illustrate the top scorer in a particular category. The leader name 906 may illustrate the top leader name. The section 908 may illustrate the over all score in the particular category. The section 910 may enable the user of the page to check similarity with the top scorer profile. The global option 912 may enable the user of the page to check for the global top scorers associated with the particular topic. The friends option 914 may enable the user of the page to check for top scorers among the connected friends associated to the particular subject. The block 916 may illustrate the top scores (e.g., may be in friends and/or globally) associated with the particular subject.

In example embodiment, FIG. 9 may illustrate the score ranking page 900 may illustrate top scores in a particular topic/discussion. The example embodiment may illustrate top scorers like Jolly Mathew, Alexander Gault, Richard Ross, Ryan Lam, with scores of 19979, 9052, 1159, 365 respectively. The example embodiment may also enable the user of the page to check similarity with the top scorers. In addition, the score ranking page 900 may illustrate Jolly Mathew as the 1^{st} highest scorer, followed by Alexander Gault, Richard Ross, and Ryan Lam.

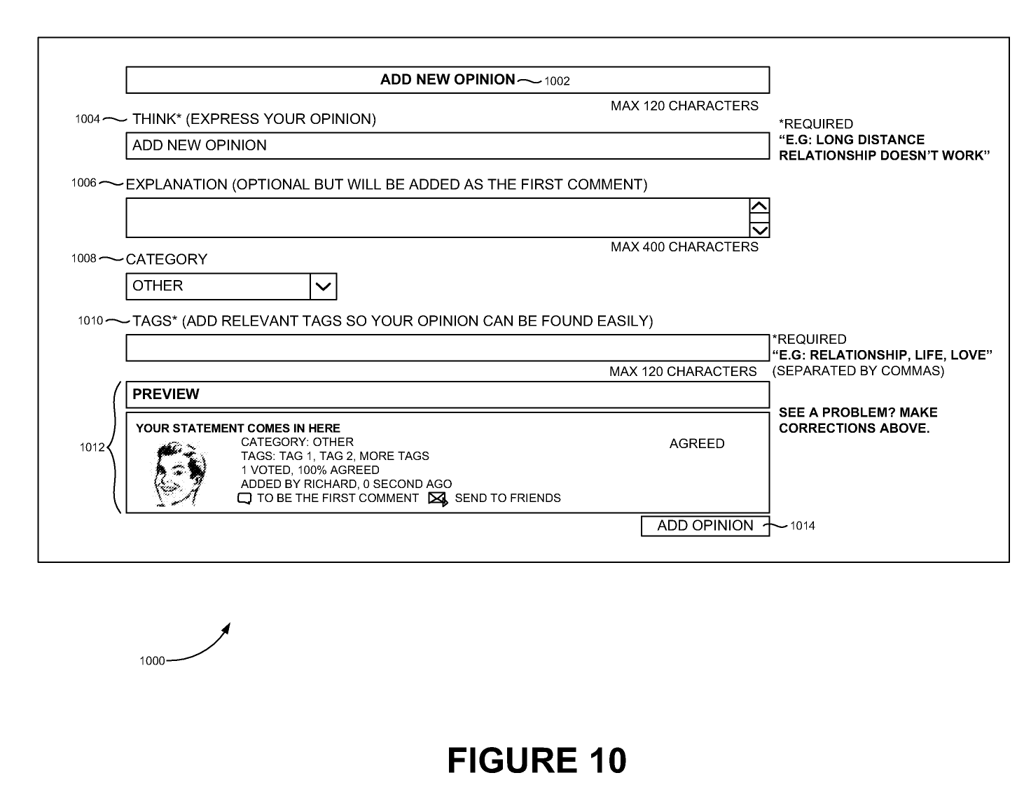

FIG. 10 is a user interface view of adding an opinion, according to one embodiment. Particularly, FIG. 10 illustrates an add new opinion 1002, a think section 1004, an explanation section 1006, a category section 1008, a tags section 1010, a preview block 1012, and an add opinion 1014, according to one embodiment.

The add new opinion 1002 block may indicates that the page may enable the user to add new opinions of the users interest. The think section 1004 may enable the user of the page to add new opinions of the user's choice. The explanation section 1006 may enable the user to add explanation to the opinion that the user may post. The category section 1008 may enable the user of the page to check for categories that the opinion may match with. The tags section 1010 may enable the user to add tags to his opinion so that his opinion can be found while searching in the global network 402. The preview block 1012 may illustrate the preview display opinion the user may prepared to it. The preview block 1012 may display the way that the opinion may be displayed to the other users when they find the opinion through search or by other means. The add opinion 1014 may be a hyperlink (e.g., button, etc.) that may enable the user to add the new opinion after the preview and satisfaction of the user.

In example embodiment, FIG. 10 may illustrate the user interface view 1000 that may enable the user to add new opinion with explanation, category, tags, preview, etc.

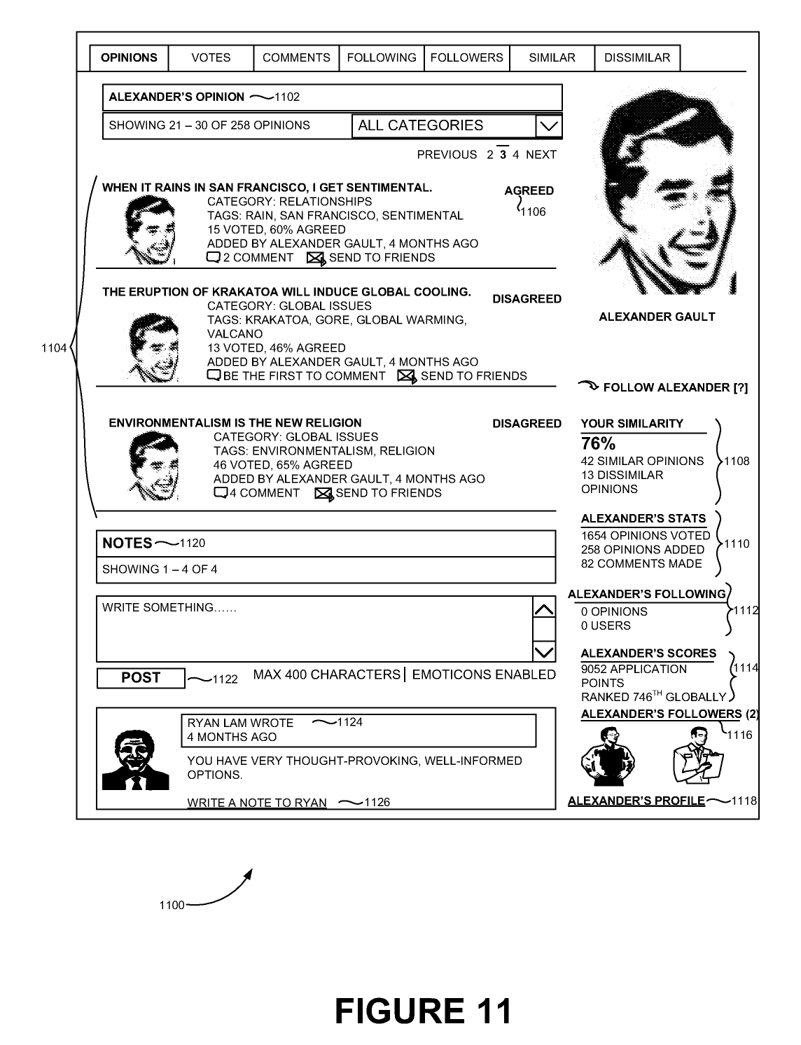

FIG. 11 is a user interface view of a user page displaying a likeness profile, according to one embodiment. Particularly, FIG. 11 illustrates Alexander's opinion 1102, opinions 1104, an agreed status 1106, your similarity section 1108, Alexander's stats section 1110, Alexander's following section 1112, Alexander's scores section 1114, Alexander's followers section 1116, Alexander's profile link 1118, notes 1120, a post link 1122, a comment block 1124, and reply 1126, according to one embodiment.

The Alexander's opinion 1102 may illustrate to the user of the page that the user interface view 1100 may include the Alexander's opinion 1102. The opinions 1104 may be the opinion of the other user based on a particular topic. The agreed status 1106 may illustrate that the particular user may have agreed to the opinion. The “your similarity section” 1108 may illustrate a similarity between the profile of Alexander's and the profile of the user who may be using the page. The Alexander's stats section 1110 may illustrate how many other users have voted their opinion in response to the Alexander's opinion how many have added their opinions in response to the Alexander's opinion and how many of them have made comments on the opinion. The Alexander's following section 1112 may illustrate to the user of the page that to whom the Alexander may be following. The Alexander's scores section 1114 may illustrate the Alexander's score. The Alexander's followers section 1116 may illustrate the followers of Alexander. The Alexander's profile link 1118 may be a hyper link that may navigate the user of the page to the Alexander's profile. The notes 1120 block may enable the user of the page to add notes. The post link 1122 may enable the user of the page to post the notes which may be prepared in the notes 1120 block. The comment block 1124 may illustrate the comment made on the opinion of the Alexander. The reply 1126 may enable the user to send a message to the person who may have made a comment on the opinion.

In example embodiment, the FIG. 11 may illustrate Alexander's opinions, similarity with the Alexander, Alexander's stats, whom Alexander may be following, followers of Alexander, Alexander's scores, Alexander's profile, notes section, comment section, reply section, etc.

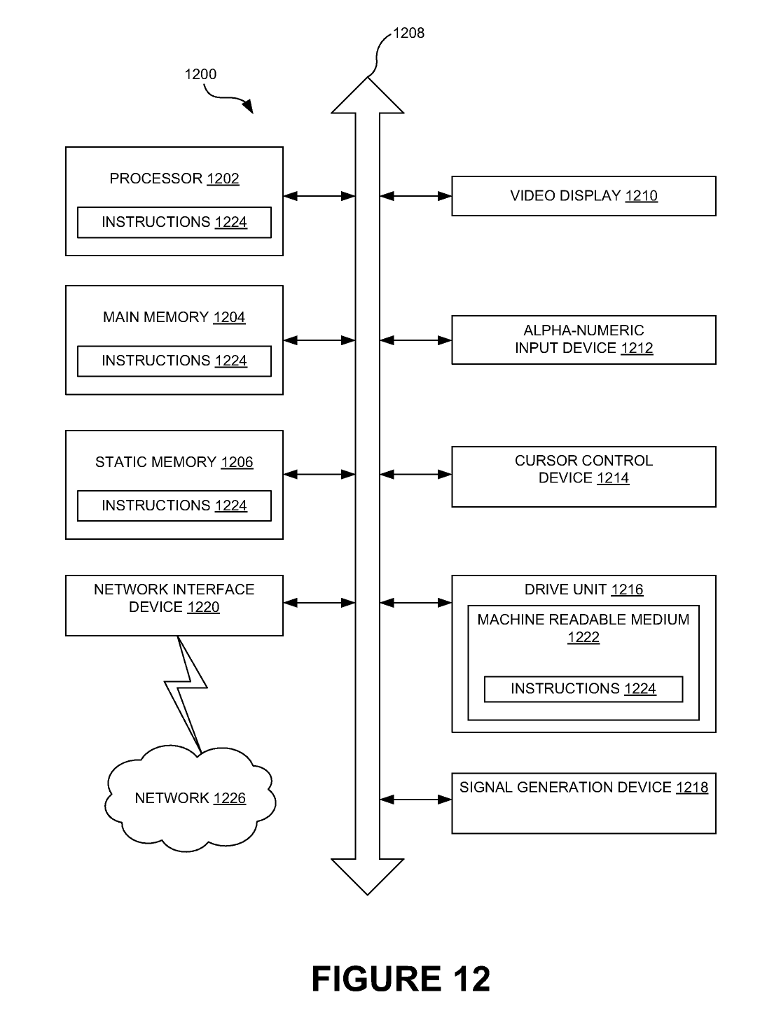

FIG. 12 is a diagrammatic system view 1200 of a data processing system in which any of the embodiments disclosed herein may be performed, according to on embodiment. Particularly, the diagrammatic system view 1200 of FIG. 12 illustrates a processor 1202, a main memory 1204, a static memory 1206, a bus 1208, a video display 1210, an alpha-numeric input device 1212, a cursor control device 1214, a drive unit 1216, a signal generation device 1218, a network interface device 1220, a machine readable medium 1222, instructions 1224, and a network 1226, according to one embodiment.

The diagrammatic system view 1200 may indicate a personal computer and/or the data processing system in which one or more operations disclosed herein are performed. The processor 1202 may be a microprocessor, a state machine, an application specific integrated circuit, a field programmable gate array, etc. (e.g., Intel® Pentium® processor). The main memory 1204 may be a dynamic random access memory and/or a primary memory of a computer system.

The static memory 1206 may be a hard drive, a flash drive, and/or other memory information associated with the data processing system. The bus 1208 may be an interconnection between various circuits and/or structures of the data processing system. The video display 1210 may provide graphical representation of information on the data processing system. The alpha-numeric input device 1212 may be a keypad, a keyboard and/or any other input device of text (e.g., a special device to aid the physically handicapped).

The cursor control device 1214 may be a pointing device such as a mouse. The drive unit 1216 may be the hard drive, a storage system, and/or other longer term storage subsystem. The signal generation device 1218 may be a bios and/or a functional operating system of the data processing system. The network interface device 1220 may be a device that performs interface functions such as code conversion, protocol conversion and/or buffering required for communication to and from the network 1226. The machine readable medium 1222 may provide instructions on which any of the methods disclosed herein may be performed. The instructions 1224 may provide source code and/or data code to the processor 1202 to enable any one or more operations disclosed herein.

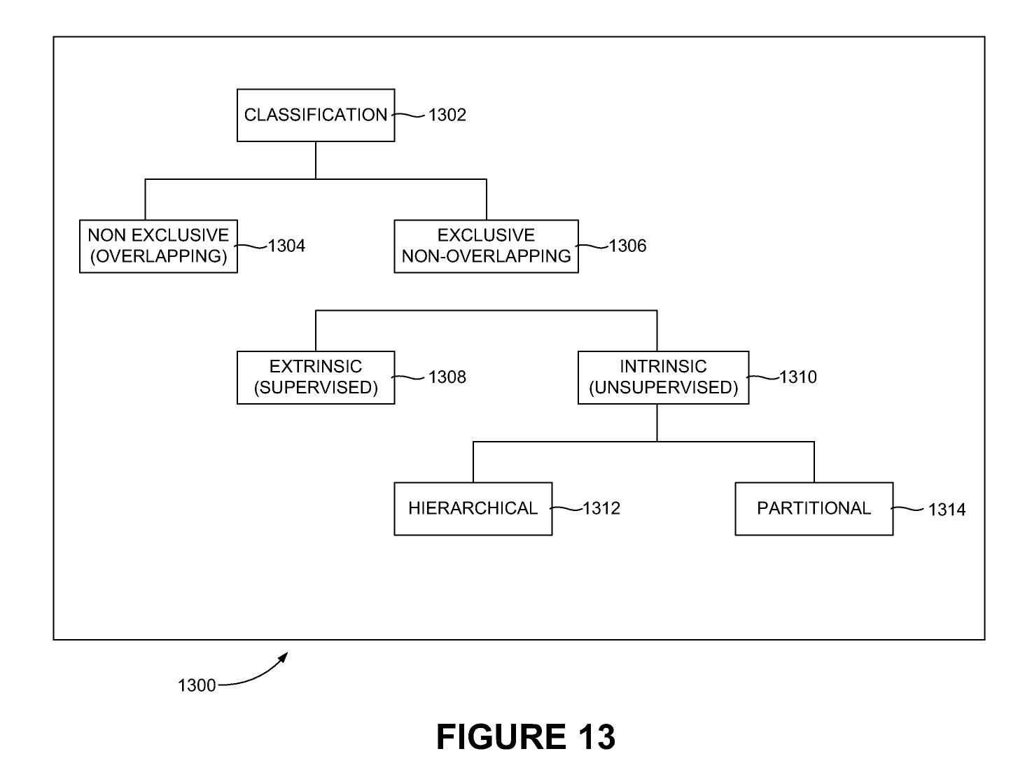

FIG. 13 is a tree diagram of cluster analysis classification types, according to one embodiment. Particularly, FIG. 13 illustrates a classification 1302, a non-exclusive (overlapping) 1304, exclusive non-overlapping 1306, extrinsic (supervised) 1308, intrinsic (unsupervised) 1310, hierarchical 1312, and partitional 1314, according to one embodiment.

The classification 1302 block may classify objects (e.g., data category) into different categories. The non-exclusive (overlapping) 1304 classification may assign objects into different classes (e.g., class may be a group) to several classes (e.g., grouping of diseases in a person, and a person can have several diseases simultaneously). The exclusive (non-overlapping) 1306 classification may be a category which may partition a set of objects (e.g., entity). The extrinsic (supervised) 1308 may be a category where the objects may be grouped with priori existing category (e.g., using labels). The intrinsic (unsupervised) 1310 may be a category in which objects may be grouped into categories which may not have priori categories (e.g., priori labels). The hierarchical 1312 clustering may be a sequence of partitions in which each partition may be nested in a sequence. The partitional 1314 classification may produce partitions of the data set.

In example embodiment, the opinion data 100 may be classified into non-exclusive or exclusive groups. The opinion data 100 may be classified into extrinsic and intrinsic categories. The intrinsic category of opinion data 100 may be further classified into hierarchical and partitional categories.

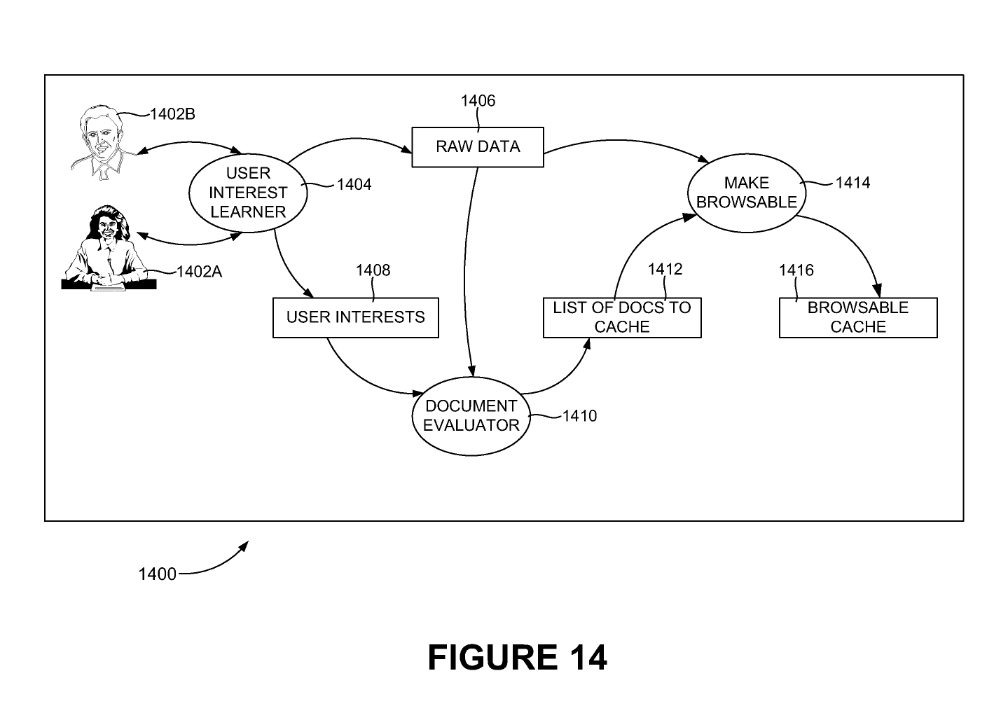

FIG. 14 is a data flow diagram of learning a user interest and evaluating a document relevancy, according to one embodiment. Particularly, FIG. 14 illustrates users 1402A-B, an user interest learner 1404, a raw data 1406, an user interests 1408, a document evaluator 1410, make browsable 1412, list of docs to cache 1414, and browsable cache 1416, according to one embodiment.

The users 1402A-B may upload data through profiles, opinions, etc. in a network. The user interest learner 1404 may analyze the data in profile (e.g., interests, opinions, etc.) and may classify the opinion data pure interest data and a raw data. The raw data 1406 may be a data (e.g. opinion data, etc.) which may be further refined to get finer information about the interests. The user interests 1408 may be interests obtained from the profile of the user and/or from the user data (e.g., opinions, comments, etc.). The document evaluator 1410 may get inputs from the raw data 1406 and/or from the user interests 1408 and may evaluate the information. The make browsable 1412 may get inputs from the raw data 1406 and/or the list of docs to cache to make the information browsable. The list of docs to cache 1414 may be the information that may include data that may be put in cache for relevancy check. The browsable cache 1416 may include the information (e.g., relevant document) that may be browsable.

In example embodiment, the data from users may be categorized inside a network (e.g., LAN) into categories. The data from the users may be categorized into different groups which may be similar in small networks such as LAN. The system may study, organize and manage the cache based on the users interest. The documents entering the network may be categorized by this system based on the users interest.

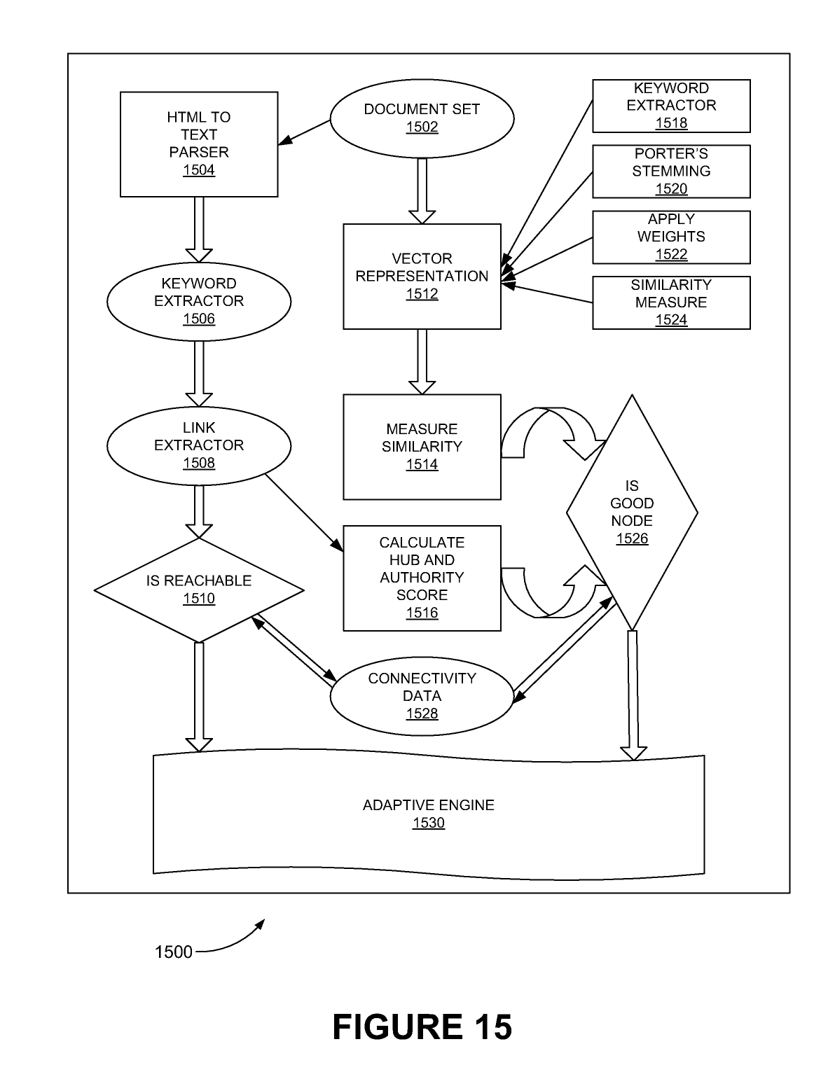

FIG. 15 is a flow chart of learning a user profile, according to one embodiment. A document set 1502 may include a set of documents in which interest of the user may lie. The document set 1502 may be sent to HTML to text parser 1504 to extract text from HTML data. The document set 1502 may be converted to vector representation 1512. The HTML to text parser 1504 may parse the document containing HTML into text, the output may be sent to the keyword extractor 1506. The keyword extractor 1506 may extract keywords from the text document. The link extractor 1508 may extract links from the data and may calculate hub and authority score. It may be determined whether the link data may be reachable or not, through “is reachable 1510” if the data is not reachable then the data may be sent to adaptive engine 1530.

The vector representation 1512 may be the conversion form of the document set 1502. The key word extractor 1518 may extract words from the data. The key word extractor 1518, the porter's stemming 1520, apply weights 1522, and/or from a similarity measure 1524 blocks may apply on vector representation of the data. The “your representation 1512” may produce an output data that may be used for measuring similarity. The measure similarity 1514 may calculate the similarity between the user profile vector and each vector in the entire document collection using cosine similarity measure. The calculate hub and authority score 1516 may calculate hub and authority score from the link extractor 1508. It may be determined to check whether node may good or not. If the node is good then the data may be sent to adaptive engine or else data connectivity may be checked through connectivity data 1528.

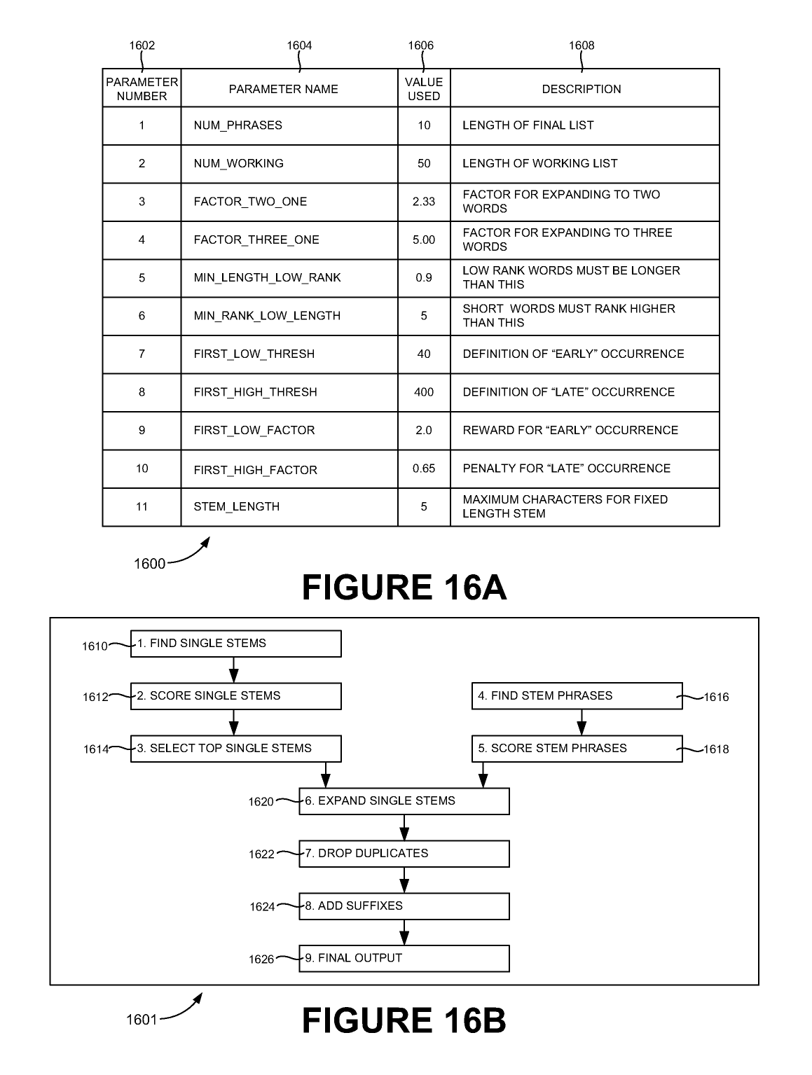

FIGS. 16A and 16B are table views of an automatic key phrase extraction algorithm, according to one embodiment. Particularly, FIG. 16A illustrates a parameter number field 1602, a parameter name field 1604, a value used field 1606, and a description field 1608, according to one embodiment. FIG. 16B illustrates a find single stems field 1610, a score single stems field 1612, a select top single stems field 1614, a find stem phrases field 1616, a score stem phrases field 1618, an expand single stems 1620, a drop duplicates field 1622, an add suffixes field 1624, and a final output field 1626, according to one embodiment.

The parameter number field 1602 may represent a parameter number. The parameter name field 1604 may illustrate the parameters. The value used field 1606 may illustrate the value associated with each of the parameter name. The description field 1608 may illustrate the description associated to the parameter name. The find single stems field 1610 may find single stems. The score single stems field 1612 may add scores to single stems that may be obtained from the find single stems field 1610. The select top single stems field 1614 may select top single stem from the set of stems based on individual scores of the stems from the individual score single stem. The find stem phrases field 1616 may find for stem phrases. The score stem phrases field 1618 may add scores to the stem phrases. The “expand single stems 1620” may expand all the single stems. The drop duplicates field 1622 may drop all the duplicate copies of the stems. The add suffixes field 1624 may add suffixes to the stems. The final output field 1626 may provide final output based on the scores on stems.

In example embodiment, the FIG. 16A may illustrate a table view 1600 which may include the parameter number field 1602, the parameter name field 1604, the value used field 1606, and the description field 1608. The table view 1600 may give parameter names and values associated to the parameters along with their description. FIG. 16B may illustrate the nine steps of the key phrase extraction algorithm. The way the final output that may be obtained from finding single stems, stem phrases, by assigning them scores, dropping duplicates, adding suffixes and finally producing output.

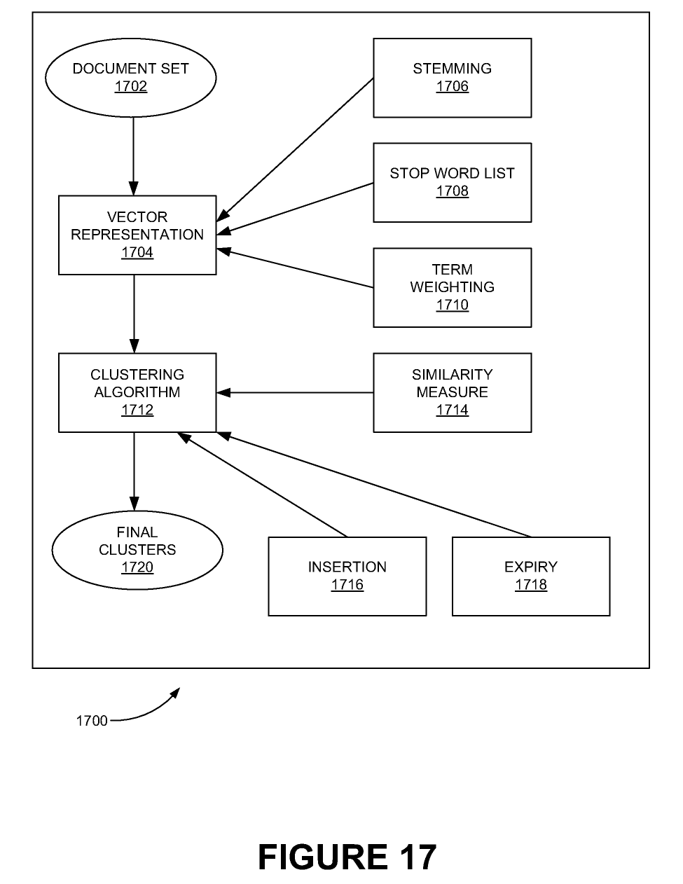

FIG. 17 is a flow diagram of clustering with hierarchical and incremental approach, according to one embodiment. Particularly, FIG. 17 illustrates a document set 1702, a vector representation 1704, a stemming 1706, a stop word list 1708, a term weighting 1710, a clustering algorithm 1712, a similarity measure 1714, an insertion 1716, an expiry 1718, and a final clusters 1720, according to one embodiment.

The document set 1702 may be a set of information (e.g., may include profile details, opinion data, comments, etc.). The vector representation 1704 may be the result of conversion of the document set 1702. The vector representation 1704 may take inputs from the stemming 1706, the stop word list 1708, the term weighting 1710, and/or from the similarity measure 1524 blocks and may produce an output data that may be used for measuring similarity. The stemming 1706 may identify stems, stem phrases in documents. The stop word list 1708 may catch for key words in the document. The term weighting 1710 may add values to the terms. The clustering algorithm 1712 may apply algorithms like K-means algorithm, etc. for clustering. The similarity measure 1714 may calculate the similarity between the user profile vector and each vector in the entire document collection using cosine similarity measure. The insertion 1716 may enable insertions of cluster. The expiry 1718 may remove unwanted clusters. The final clusters 1720 may be the final output clusters obtained from the clustering algorithm 1712.

In example embodiment, FIG. 17 may illustrate the flow diagram where the document set 1702 may be converted to vector representation 1704. The stemming 1706, the stop word list 1708, the term weighting 1710 operations may be performed and by applying clustering algorithm 1712, the similarity measure 1714 we may get the final clusters 1720.

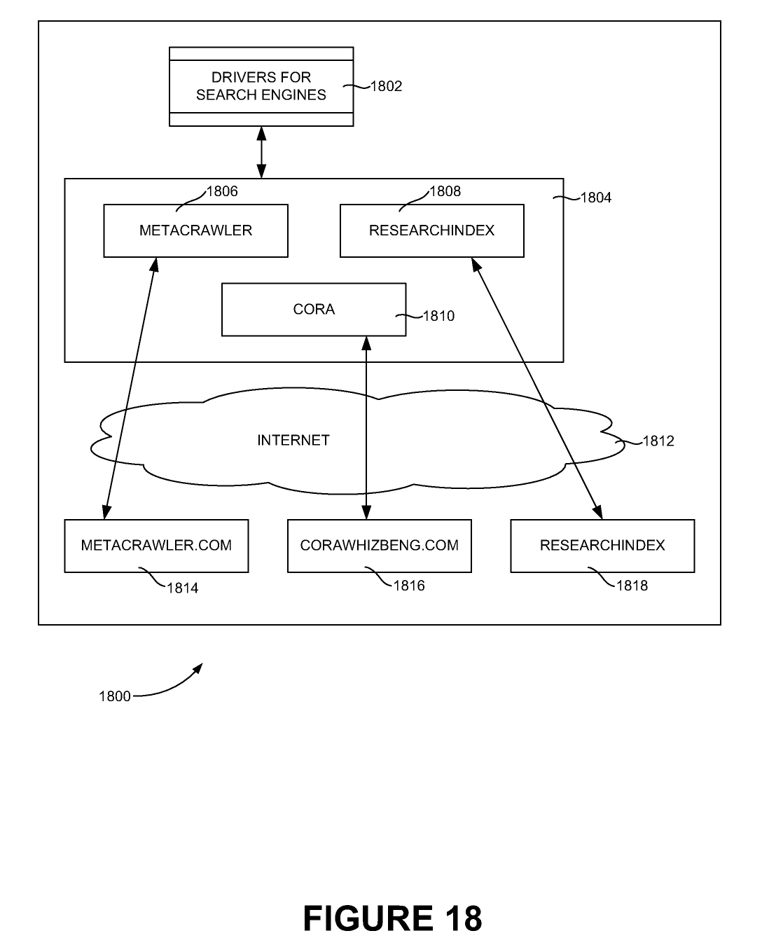

FIG. 18 is a block diagram of a cluster results of web search engines algorithm, according to one embodiment. Particularly, FIG. 18 illustrates a block 1802, a block 1804, a metacrawler 1806, a researchindex 1808, a cora 1810, an internet 1812, a metacrawler.com 1814, a corawhizbeng.com 1816, and a research index 1818, according to one embodiment.

The block 1802 may provide drivers for the web search engines. The block 1804 may search for metadata, index data, technical information details etc. The metacrawler 1806 may give results including queries from other search engines. The researchindex 1808 may search for data based on index. The cora 1810 may be a search engine for searching technical publications. The internet 1812 may provide communication with the outer world for information exchange. The metacrawler.com 1814 may be an application which may be a search engine of a search engines that may be used for searching search engines for the required data. The corawhizbeng.com 1816 may be an application that may search for technical publications. The research index 1818 may be an application that may research index from various websites.

In example embodiment, FIG. 18 may illustrate the block 1804 which may be the searching tool which may include the metacrawler 1806, the researchindex 1808, and/or the cora 1810. The searching tool may communicate with the respective application through the internet 1812. The searching tool may be enabled using the drivers for the search engines.

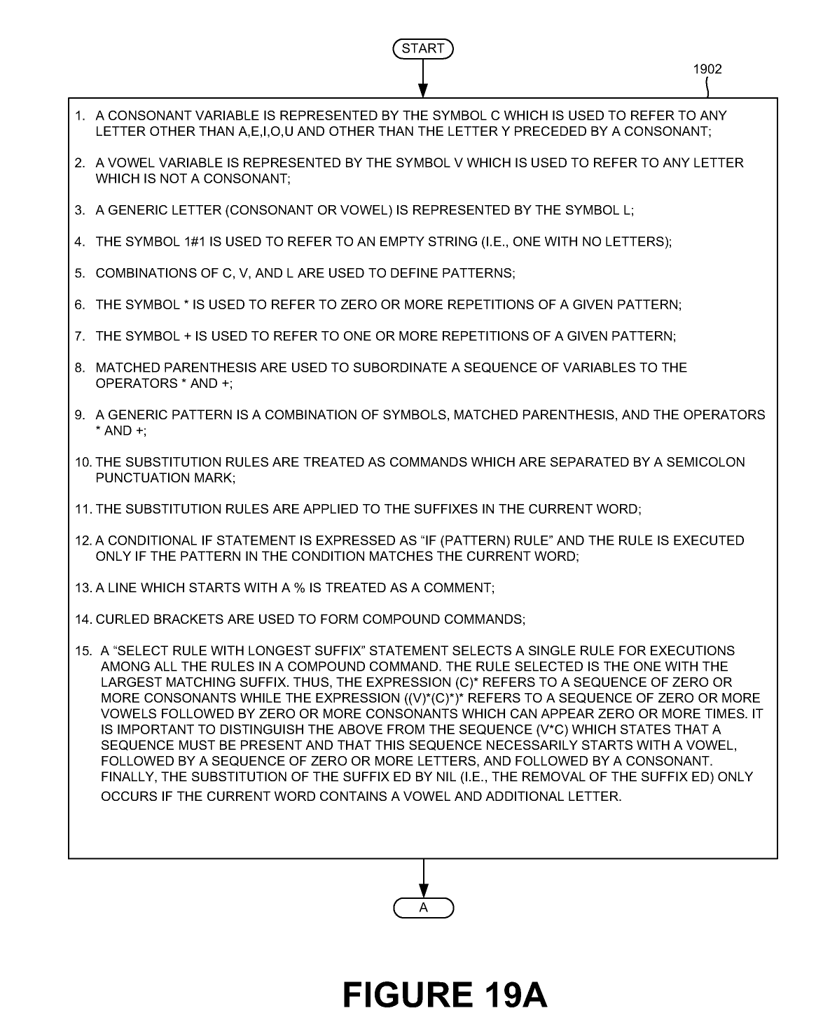

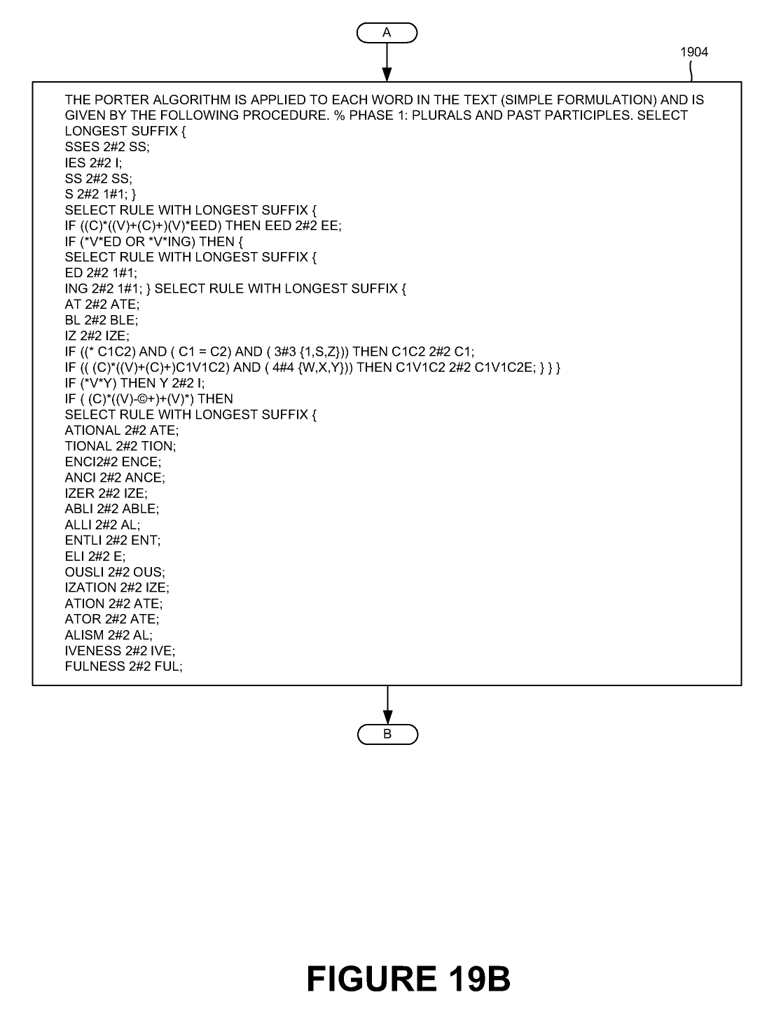

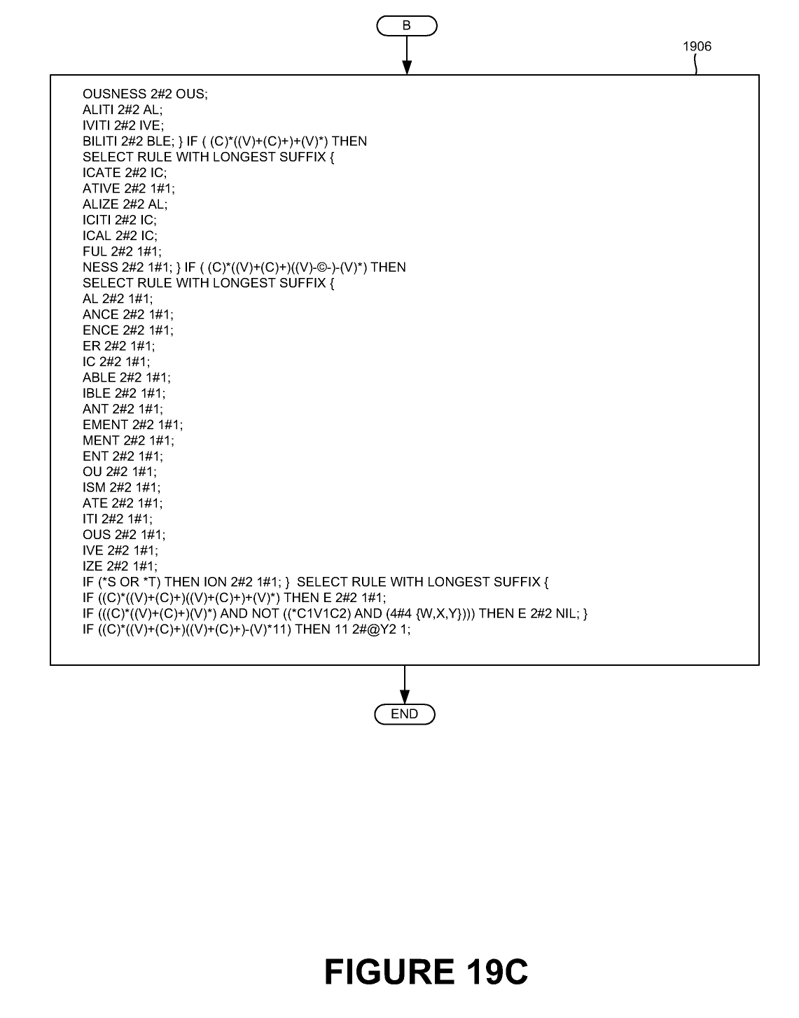

FIG. 19A is a flow of extracting meaningful words, according to one embodiment. In operation 1902, A consonant variable may be represented by the symbol c which is used to refer to any letter other than ‘a, e, i, o, u’ and other than the letter y preceded by a consonant. A vowel variable may be represented by the symbol ‘v’ which is used to refer to any letter which is not a consonant. A generic letter (consonant or vowel) may be represented by the symbol ‘1’. The symbol 1#1 is used to refer to an empty string (i.e., one with no letters). Combinations of c, v, and l may be used to define patterns. The symbol * may be used to refer to zero or more repetitions of a given pattern. The symbol + may be used to refer to one or more repetitions of a given pattern. Matched parenthesis may be used to subordinate a sequence of variables to the operators * and +. A generic pattern may be a combination of symbols, matched parenthesis, and the operators * and +. The substitution rules may be treated as commands which are separated by a semicolon punctuation mark.

The substitution rules may be applied to the suffixes in the current word. A conditional if statement may be expressed as “if (pattern) rule” and the rule may be executed only if the pattern in the condition matches the current word. A line which starts with a % may be treated as a comment. The curled brackets are used to form compound commands. A “select rule with longest suffix” statement selects a single rule for executions among all the rules in a compound command. The rule selected may be the one with the largest matching suffix. Thus, the expression (c)* refers to a sequence of zero or more consonants while the expression ((v)*(c)*)* refers to a sequence of zero or more vowels may be followed by zero or more consonants which can appear zero or more times. It may be important to distinguish the above from the sequence (v*c) which states that a sequence must be present and that this sequence necessarily starts with a vowel, followed by a sequence of zero or more letters, and followed by a consonant. Finally, the substitution of the suffixed by nil (i.e., the removal of the suffixed) only occurs if the current word contains a vowel and additional letter.

FIG. 19B is a continuation of the flow of FIG. 19A having additional processes, according to one embodiment. In operation 1904, The porter algorithm may be applied to each word in the text (simple formulation) and is given by the following procedure. % phase 1: plurals and past participles. Select longest suffix

```
    {
    sses 2#2 ss;
    ies 2#2 i;
    ss 2#2 ss;
    s 2#2 1#1;
    }
select rule with longest suffix {
if ((c)*((v)+(c)+)(v)*eed) then eed 2#2 ee;
if (*v*ed or *v*ing) then {
              select rule with longest suffix {
              ed 2#2 1#1;
              ing 2#2 1#1;
              }
              select rule with longest suffix {
              at 2#2 ate;
              bl 2#2 ble;
              iz 2#2 ize;
              if ((* c1c2) and (c1 = c2) and ( 3#3 {1,s,z})) then
              c1c2 2#2 c1;
              if (( (c)*((v)+(c)+)c1v1c2) and ( 4#4 {w,x,y})) then
              c1v1c2 2#2 c1v1c2e;
                                            }
                            }
                            }
              if (*v*y) then y 2#2 i;
              if ( (c)*((v)− ©+)+(v)*) then
              select rule with longest suffix {
              ational 2#2 ate;
              tional 2#2 tion;
              enci2#2 ence;
              anci 2#2 ance;
              izer 2#2 ize;
              abli 2#2 able;
              alli 2#2 al;
              entli 2#2 ent;
              eli 2#2 e;
              ousli 2#2 ous;
              ization 2#2 ize;
              ation 2#2 ate;
              ator 2#2 ate;
              alism 2#2 al;
              iveness 2#2 ive;
              fulness 2#2 ful;
```

FIG. 19C is a continuation of the flow of FIG. 19B having additional processes, according to one embodiment.

ousness 2#2 ous;
aliti 2#2 al;
iviti 2#2 ive;
biliti 2#2 ble;
}
if ( (c)*((v)+(c)+)+(v)*) then
select rule with longest suffix {
icate 2#2 ic;
ative 2#2 1#1;
alize 2#2 al;
iciti 2#2 ic;
ical 2#2 ic;
ful 2#2 1#1;
ness 2#2 1#1; } if ( (c)*((v)+(c)+)((v)− ©−)−(v)*) then
select rule with longest suffix {
al 2#2 1#1;
ance 2#2 1#1;
ence 2#2 1#1;
er 2#2 1#1;
ic 2#2 1#1;
able 2#2 1#1;
ible 2#2 1#1;
ant 2#2 1#1;
ement 2#2 1#1;
ment 2#2 1#1;
ent 2#2 1#1;
ou 2#2 1#1;
ism 2#2 1#1;
ate 2#2 1#1;
iti 2#2 1#1;
ous 2#2 1#1;
ive 2#2 1#1;
ize 2#2 1#1;
if (*s or *t) then ion 2#2 1#1; } select rule with longest suffix {
if ((c)*((v)+(c)+)((v)+(c)+)+(v)*) then e 2#2 1#1;
if (((c)*((v)+(c)+)(v)*) and not ((*c1v1c2) and (4#4 {w,x,y}))) then e 2#2
nil; }
if ((c)*((v)+(c)+)((v)+(c)+)−(v)*11) then 11 2#@y2 1;

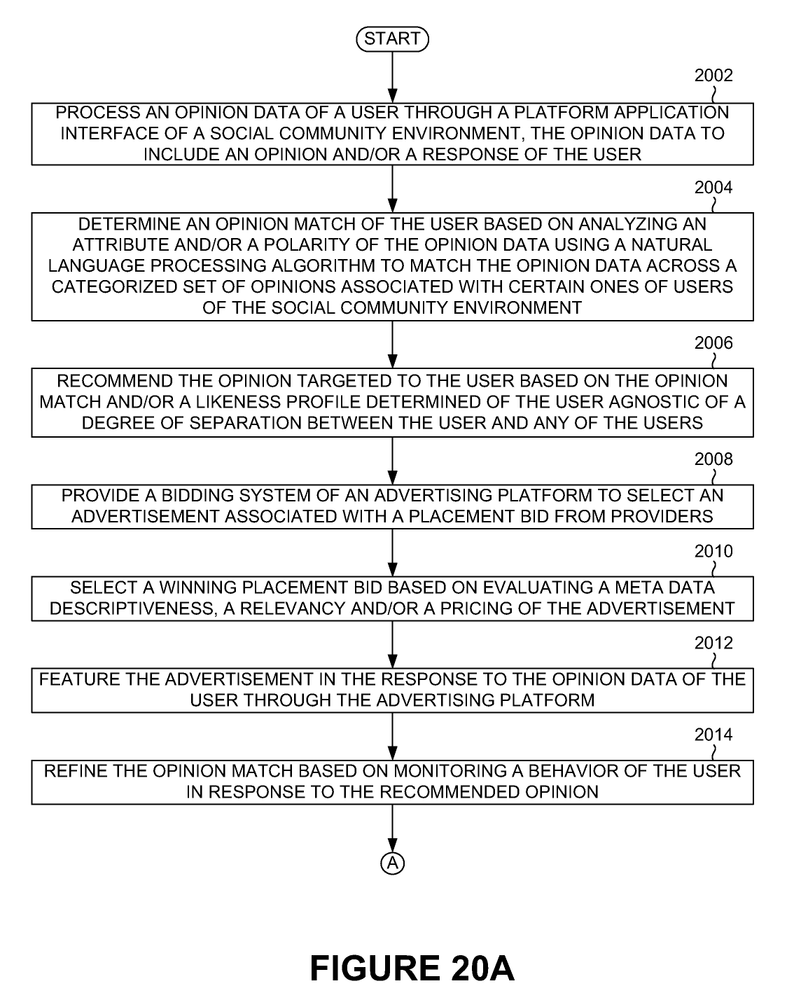

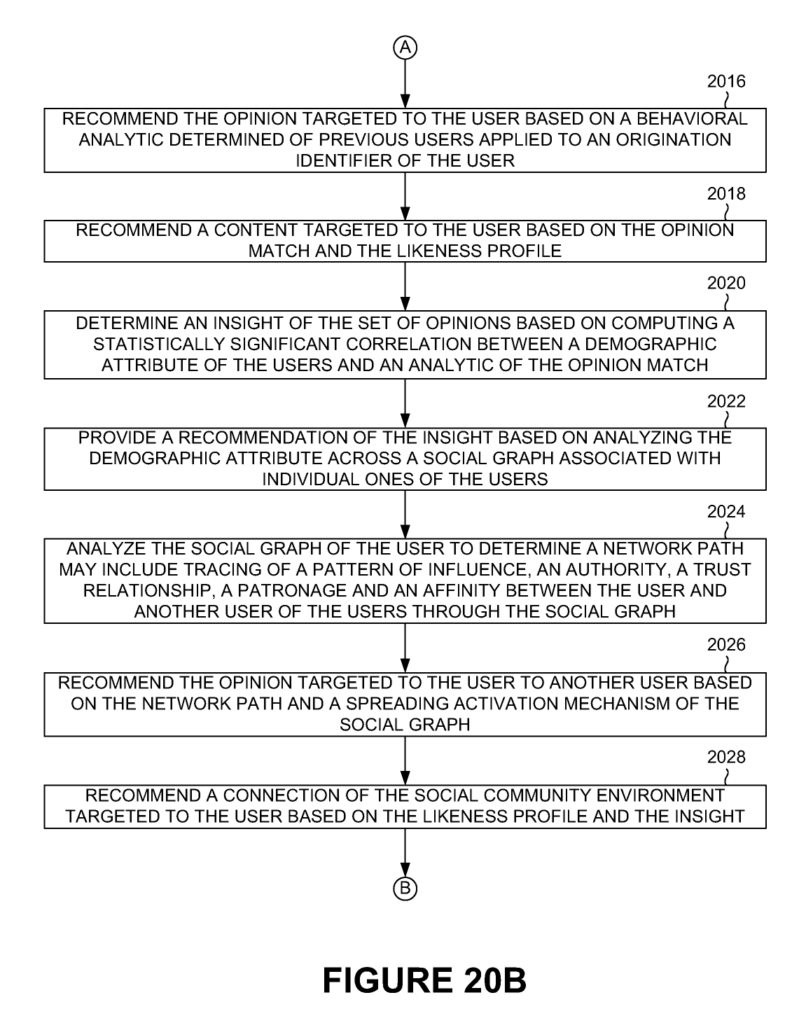

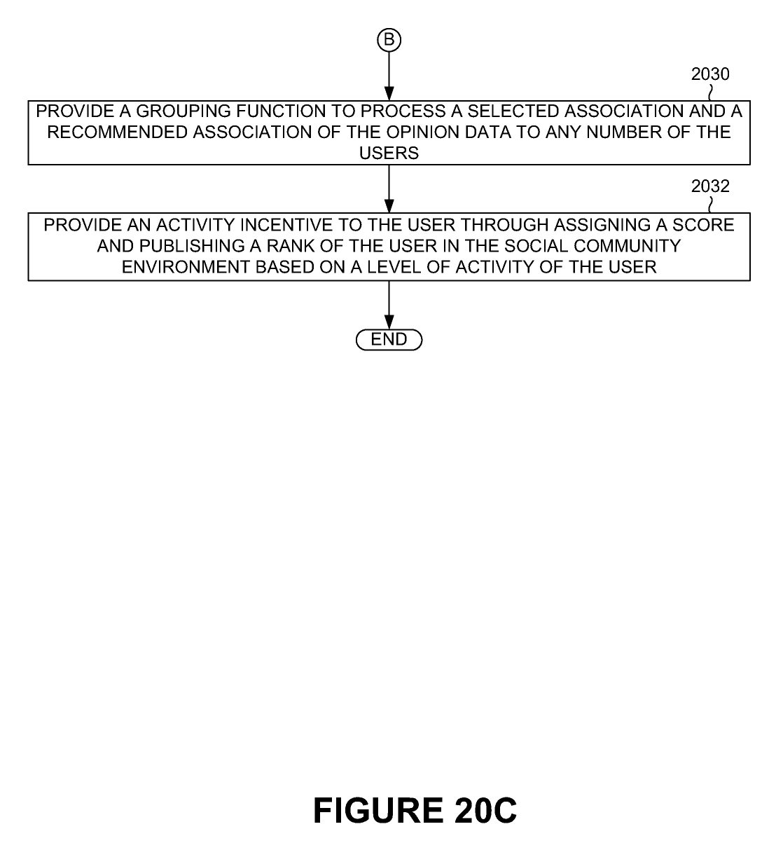

FIG. 20A is a process flow of processing an opinion data (e.g., the opinion data 100 of FIG. 1) of a user through a platform application (e.g., the platform application 112 of FIG. 1) interface of a social community environment (e.g., the social community environment 108A-N of FIG. 1), according to one embodiment. In operation 2002, the opinion data 100 of a user may be processed through a platform application interface (e.g., using the processing module 104 of FIG. 1) of the social community environment 108A-N. The opinion data 100 may include an opinion and/or a response of the user. In operation 2004, an opinion match of the user (e.g., using the matching module 306 of FIG. 3) based on analyzing any one of an attribute (e.g., using the analysis module 304 of FIG. 3) and a polarity of the opinion data may be determined (e.g., using the opinion module 102 of FIG. 1) using a natural language processing algorithm to match the opinion data across a categorized set of opinions (e.g., using the opinion module 102 of FIG. 1) associated with certain ones of a users (e.g., the users 110A-N of FIG. 1) of the social community environment 108A-N.

In operation 2006, the opinion targeted to the user based on any one of the opinion match (e.g., the matching module 306 of FIG. 3) and a likeness profile determined of the user agnostic of a degree of separation may be recommended (e.g., using the recommendation module 106 of FIG. 2) between the user and any one of the users. In operation 2008, a bidding system (e.g., using the bid module 232 of FIG. 2) of an advertising platform may be provided to select an advertisement (e.g., using the advertising module 114 of FIG. 1) associated with a placement bid from providers (e.g., using the bid module 232 of FIG. 2).

In operation 2010, a winning placement bid based on evaluating (e.g., using the evaluation module 234 of FIG. 2) a meta data, descriptiveness, a relevancy and/or a pricing of the advertisement (e.g., using the advertising module 114 of FIG. 1) may be selected. In operation 2012, the advertisement in the response to the opinion data of the user (e.g., using the response module 208 of FIG. 2) may be featured through the advertising platform (e.g., using the advertising module 114 of FIG. 1). The providers may include a commercial entity, a brand, a sponsor, and/or a partner. In operation 2014, the opinion match based on monitoring a behavior of the user (e.g., using the matching module 306 of FIG. 3) may be refined in response to the recommended opinion (e.g., using the response module 208 of FIG. 2).

FIG. 20B is a continuation of process flow of FIG. 20A, illustrating additional operations, according to one embodiment. In operation 2016, it may be recommended the opinion targeted to the user (e.g., using the recommendation module 106 of FIG. 2) based on a behavioral analytic determined of previous users (e.g., using the analysis module 304 of FIG. 3) applied to an origination identifier of the user. The origination identifier may include a domain name, a domain extension, a server location, an IP address and/or a network name associated with the user.

In operation 2018, it may be recommended a content targeted to the user (e.g., using the recommendation module 106 of FIG. 2) based on the opinion match and the likeness profile (e.g., using the opinion module 102 of FIG. 1). The content may include a syndicated content, a sponsor content, a partner content, a public content and/or a private content independent of the social community environment 108A-N. In operation 2020, it may be determined an insight of the set of opinions (e.g., using the insight module 216 of FIG. 2) based on computing a statistically significant correlation between a demographic attribute of the users 110A-N (e.g., using the attribute module 316 of FIG. 3) and an analytic of the opinion match (e.g., using the opinion module 102 of FIG. 1).

In operation 2022, a recommendation of the insight (e.g., using the recommendation module 106 of FIG. 2) based on analyzing the demographic attribute (e.g., using the analysis module 304 of FIG. 3) across a social graph (e.g., the social graph 406A-C of FIG. 4) may be provided associated with individual ones of the users 110A-N. The demographic attribute may include an age attribute, a gender attribute, a geographic attribute, a cultural attribute, a social attribute and/or a professional attribute (e.g., as illustrated in the attribute module 316 of FIG. 3).

In operation 2024, the social graph 406A-C of the user may be analyzed (e.g., using the analysis module 304 of FIG. 3) to determine a network path (e.g., using the network module 228 of FIG. 2) to include tracing a pattern of influence, an authority, a trust relationship, a patronage and/or an affinity between the user and another user of the users 110A-N through the social graph 406A-C. In operation 2026, the opinion targeted to the user (e.g., using the opinion module 102 of FIG. 1) may be recommended to another user based on the network path (e.g., using the network module 228 of FIG. 2) and a spreading activation mechanism of the social graph 406A-C. The spreading activation mechanism may include propagating an activation of nodes based on a linkage to a set of source nodes determined of the social graph 406A-C.

In operation 2028, it may be recommended a connection of the social community environment 108A-N targeted to the user (e.g., using the recommendation module 106 of FIG. 2) based on the likeness profile and the insight (e.g., using the likeness module 318 of FIG. 3).

FIG. 20C is a continuation of process flow of FIG. 20B, illustrating additional operations, according to one embodiment. In operation 2030, a grouping function may be provided to process (e.g., using the processing module 104 of FIG. 1) a selected association and a recommended association of the opinion data 100 (e.g., using the opinion module 102 of FIG. 1) to any number of the users 110A-N. In operation 2032, an activity incentive may be provided to the user through assigning a score and/or publishing a rank of the user in the social community environment 108A-N based on a level of activity of the user.

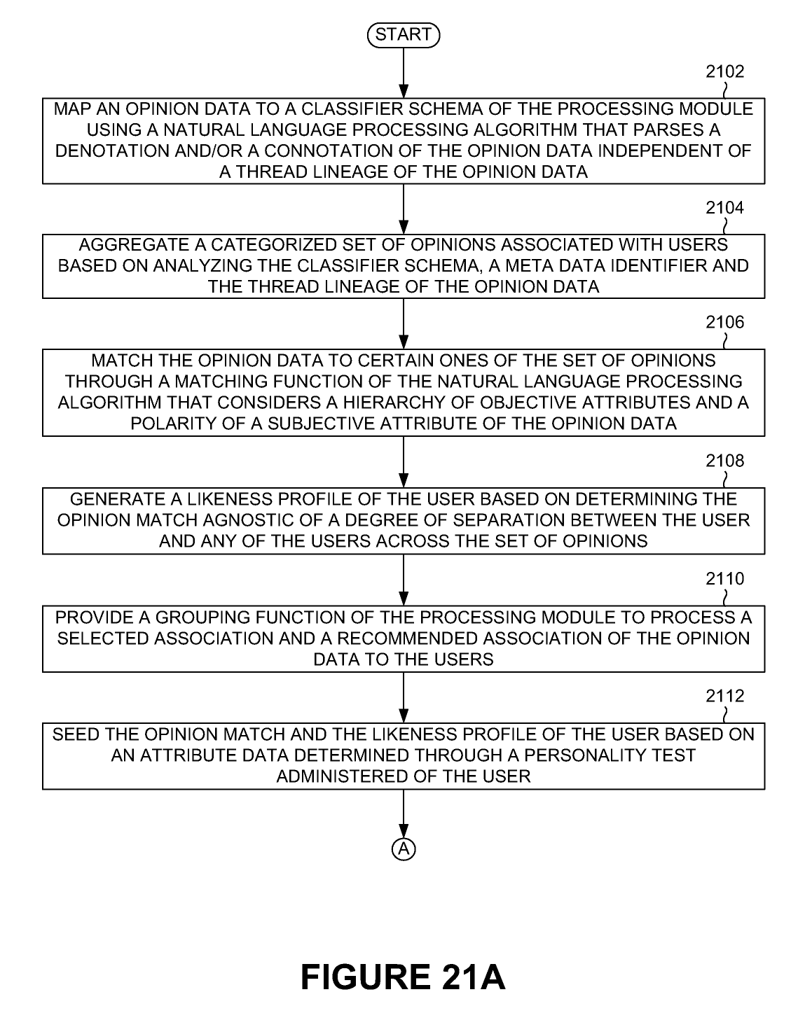

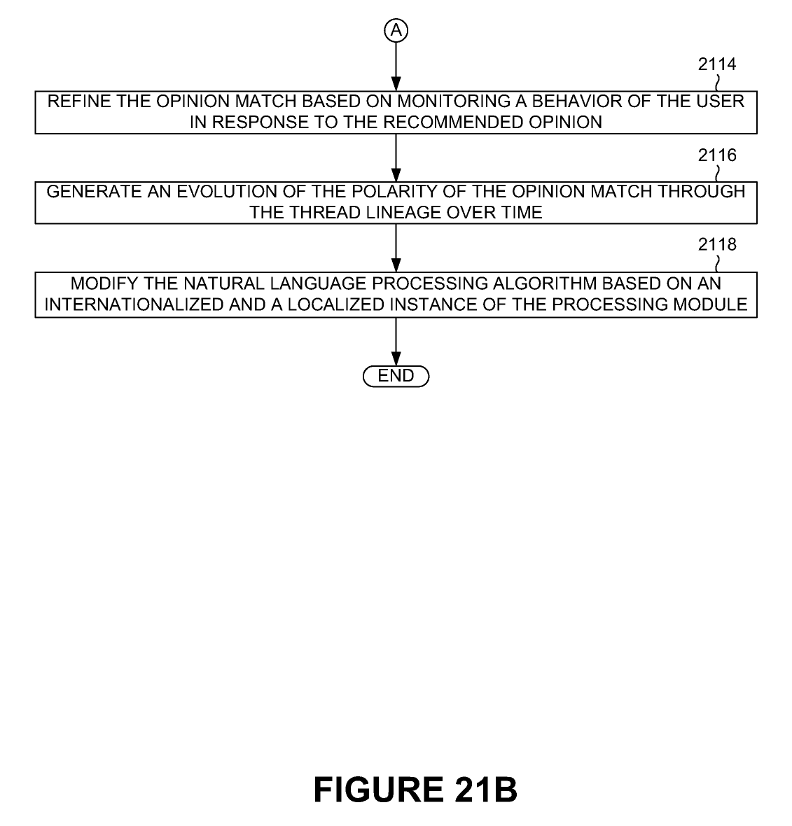

FIG. 21A is a process flow of mapping an opinion data (e.g., the opinion data 100 of FIG. 1) to a classifier schema of the processing module (e.g., the processing module 104 of FIG. 1) using a natural language processing algorithm, according to one embodiment. In operation 2102, the opinion data 100 may be mapped to a classifier schema of the processing module 104 using a natural language processing algorithm that parses at least one of a denotation and a connotation of the opinion data 100 (e.g., using the processing module 104 of FIG. 1) independent of a thread lineage of the opinion data 100. In operation 2104, a categorized set of opinions may be aggregated associated with users (e.g., the users 110A-N of FIG. 1) (e.g., using the category module 310 of FIG. 3) based on analyzing the classifier schema, a meta data identifier (e.g., using the aggregation module 210 of FIG. 2) and the thread lineage of the opinion data 100.

In operation 2106, the opinion data 100 may be matched (e.g., using the matching module 306 of FIG. 3) to certain ones of the set of opinions through a matching function of the natural language processing algorithm (e.g., using the processing module 104 of FIG. 1) that considers a hierarchy of objective attributes and/or a polarity of a subjective attribute of the opinion data 100 (e.g., using the opinion module 102 of FIG. 1). In operation 2108, a likeness profile of the user based on determining the opinion match agnostic of a degree of separation (e.g., using the likeness module 318 of FIG. 3) may be generated between the user and any of the users across the set of opinions (e.g., using the opinion module 102 of FIG. 1).

In operation 2110, a grouping function of the processing module 104 may be provided to process a selected association and a recommended association of the opinion data 100 to the users 110A-N (e.g., using the processing module 104 of FIG. 1). In operation 2112, the opinion match and the likeness profile of the user may be seeded based on an attribute data determined (e.g., using the processing module 104 of FIG. 1) through a personality test administered of the user.

FIG. 21B is a continuation of process flow of FIG. 21A, illustrating additional operations, according to one embodiment.

In operation 2114, the opinion match based on monitoring a behavior of the user may be refined in response to the recommended opinion (e.g., using the response module 208 of FIG. 2). In operation 2116, an evolution of the polarity of the opinion match may be generated through the thread lineage over time (e.g., using the attribute module 316 of FIG. 3). The thread lineage may describe a parent, a child and/or a sibling orientation of the opinion data 100 (e.g., using the opinion module 102 of FIG. 1). In operation 2118, the natural language processing algorithm may be modified based on an internationalized and a localized instance of the processing module 104 (e.g., as illustrated in the processing module 104 of FIG. 1).

Although the present embodiments have been described with reference to specific example embodiments, it will be evident that various modifications and changes may be made to these embodiments without departing from the broader spirit and scope of the various embodiments. For example, a combination of software and hardware may be used to enable the viral growth extension through recommendation optimization in online communities disclosed herein to further optimize function.

Particularly, the processing module 104, the recommendation module 106, the advertising module 114, the content module 202, the mobile module 204, the API module 206, the response module 208, the aggregation module 210, the partner module 212, the insight module 216, the web module 218, the user module 220, the platform module 222, the social graph module 224, the profile module 226, the network module 228, the interest module 230, the bid module 232, the evaluation module 234, the placement module 236, the sponsor module 238, the media module 240, the syndication module 242, the widget module 248, and the developer module 250, NLP module 302, the analysis module 304, the matching module 306, the tracking module 308, the category module 310, the segmentation module 312, the attribute module 316, and the likeness module 318 of FIG. 1-21B may be enabled using software and/or using transistors, logic gates, and electrical circuits (e.g., application specific integrated ASIC circuitry) such as the opinion circuit, the processing circuit, the recommendation circuit, the advertising circuit, the processing circuit, the recommendation circuit, the advertising circuit, the content circuit, the mobile circuit, the API circuit, the response circuit, the aggregation circuit, the partner circuit, the insight circuit, the web circuit, the user circuit, the platform circuit, the social graph circuit, the profile circuit, the network circuit, the interest circuit, the bid circuit, the evaluation circuit, the placement circuit, the sponsor circuit, the media circuit, the syndication circuit, the widget circuit, the developer circuit, the NLP circuit, the analysis circuit, the matching circuit, the tracking circuit, the category circuit, the segmentation circuit, the attribute circuit, the likeness circuit, and other circuit.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method, comprising:
processing an opinion data of a user through a platform application interface of a social community environment, the opinion data to include at least one of an opinion and a response of the user;
determining an opinion match of the user based on analyzing at least one of an attribute and a polarity of the opinion data using a natural language processing algorithm to match the opinion data across a categorized set of opinions associated with certain ones of a plurality of users of the social community environment; and
recommending the opinion targeted to the user based on at least one of the opinion match and a likeness profile determined of the user agnostic of a degree of separation between the user and any of the plurality of users.

2. The method of claim 1 further comprising:
providing a bidding system of an advertising platform to select an advertisement associated with a placement bid from a plurality of providers;
selecting a winning placement bid based on evaluating at least one of a meta data descriptiveness, a relevancy and a pricing of the advertisement; and
featuring the advertisement in the response to the opinion data of the user through the advertising platform.

3. The method of claim 2 wherein the plurality of providers to include at least one of a commercial entity, a brand, a sponsor, and a partner.

4. The method of claim 1 further comprising refining the opinion match based on monitoring a behavior of the user in response to the recommended opinion.

5. The method of claim 4 further comprising recommending the opinion targeted to the user based on a behavioral analytic determined of previous users applied to an origination identifier of the user, wherein the origination identifier to include at least one of a domain name, a domain extension, a server location, an IP address and a network name associated with the user.

6. The method of claim 1 further comprising recommending a content targeted to the user based on at least one of the opinion match and the likeness profile, wherein the content to include at least one of a syndicated content, a sponsor content, a partner content, a public content and a private content independent of the social community environment.

7. The method of claim 1 further comprising:
determining an insight of the set of opinions based on computing a statistically significant correlation between a demographic attribute of the plurality of users and an analytic of the opinion match; and
providing a recommendation of the insight based on analyzing the demographic attribute across a social graph associated with individual ones of the plurality users, wherein the demographic attribute to include at least one of an age attribute, a gender attribute, a geographic attribute, a cultural attribute, a social attribute and a professional attribute.

8. The method of claim 7 further comprising:
analyzing the social graph of the user to determine a network path to include tracing at least one of a pattern of influence, an authority, a trust relationship, a patronage and an affinity between the user and another user of the plurality of users through the social graph; and
recommending the opinion targeted to the user to another user based on at least one of the network path and a spreading activation mechanism of the social graph, wherein the spreading activation mechanism to include propagating an activation of a plurality of nodes based on a linkage to a set of source nodes determined of the social graph.

9. The method of claim 8 further comprising recommending a connection of the social community environment targeted to the user based on at least one of the likeness profile and the insight.

10. The method of claim 1 further comprising providing a grouping function to process at least one of a selected association and a recommended association of the opinion data to any number of the plurality of users.

11. The method of claim 10 further comprising providing an activity incentive to the user through at least one of assigning a score and publishing a rank of the user in the social community environment based on a level of activity of the user.

12. The method of claim 1 in a form of a machine-readable medium embodying a set of instructions that, when executed by a machine, causes the machine to perform the method of claim 1.

13. A method of a processing module, comprising:
mapping an opinion data to a classifier schema of the processing module using a natural language processing algorithm that parses at least one of a denotation and a connotation of the opinion data independent of a thread lineage of the opinion data;
aggregating a categorized set of opinions associated with a plurality of users based on analyzing at least one of the classifier schema, a meta data identifier and the thread lineage of the opinion data;
matching the opinion data to certain ones of the set of opinions through a matching function of the natural language processing algorithm that considers at least one of a hierarchy of objective attributes and a polarity of a subjective attribute of the opinion data; and
generating a likeness profile of the user based on determining an opinion match agnostic of a degree of separation between the user and any of the plurality of users across the set of opinions.

14. The method of claim 13 further comprising providing a grouping function of the processing module to process at least one of a selected association and a recommended association of the opinion data to the plurality of users.

15. The method of claim 13 further comprising seeding at least one of the opinion match and the likeness profile of the user based on an attribute data determined through a personality test administered of the user

16. The method of claim 15 further comprising refining the opinion match based on monitoring a behavior of the user in response to the recommended opinion.

17. The method of claim 16 further comprising generating an evolution of the polarity of the opinion match through the thread lineage over time, wherein the thread lineage to describe at least one of a parent, a child and a sibling orientation of the opinion data.

18. The method of claim 13 further comprising modifying the natural language processing algorithm based on at least one of an internationalized and a localized instance of the processing module.

19. A system, comprising:
a processing module to determine at least one of an opinion match of a opinion data and a likeness profile of a plurality of users of a social community environment using a natural language processing algorithm to match at least one of an attribute and a polarity of the opinion data to certain ones of a categorized set of opinions associated with the plurality of users;
a recommendation module to provide an opinion targeted to the user based on at least one of the opinion match and the likeness profile; and
an advertising module to feature an advertisement selected from a plurality of providers in a response to the opinion data of the user through an advertising platform of a platform application interface.

20. The system of claim 19 further comprising a widget of the processing module that is embeddable across different websites and platforms such that the set of opinion data to be aggregated through a user population across different social community environments.
